(19) United States
(12) Patent Application Publication
(10) Pub. No.: US 2016/0236392 A1
(43) Pub. Date: Aug. 18, 2016

(54) Molding Condition Diagnostic Device

(71) Applicant: TOYO MACHINERY & METAL CO., LTD., Akashi-shi, Hyogo (JP)

(72) Inventor: Yoshihiko AOYAMA, Akashi-shi, Hyogo (JP)

(21) Appl. No.: 15/031,453

(22) PCT Filed: Oct. 21, 2014
(86) PCT No.: PCT/JP2014/077997

§ 371 Date: Apr. 22, 2016

(30) Foreign Application Priority Data
Oct. 25, 2013 (JP) 2013-222370

(51) Int. Cl. B29C 45/76

(52) U.S. Cl. CPC B29C 45/766; B29C 45/768; B29C 2945/76939

(57) ABSTRACT

Provided is a molding condition diagnostic device which can diagnose appropriateness of a preset molding condition according to a measured value detected during continuous automatic operation, and which can then inform an operator when the molding condition is inappropriate. A molding condition diagnostic device (1) which determines appropriateness of a molding condition setting value and informs an operator of a result of the determination is provided in a molding machine. The molding condition diagnostic device (1) has an input portion (2) which receives a measured value outputted from a measurement unit 11 and a molding condition setting value set in a molding condition setting unit (30); a comparison portion (3) which compares the measured value and the molding condition setting value both received by the input portion (2) with each other; a storage portion (4) in which a criterion for determining that the molding condition setting value is inappropriate is stored; and a determination portion (5) which determines whether a comparison result of the comparison portion (3) satisfies the criterion stored in the storage portion (4) or not. When the determination portion (5) determines that the comparison result of the comparison portion (3) satisfies the criterion stored in the storage portion (4), a specific determination message according to the measured value and the molding condition setting value compared with each other is outputted to a display portion (6).

### TECHNICAL FIELD

The present invention relates to a molding condition diagnostic device provided in a molding machine such as an injection molding machine or a die casting machine. Particularly, it relates to a device which diagnoses appropriateness of a preset molding condition according to a measured value detected during continuous automatic operation or specifications of the molding machine.

### BACKGROUND ART

A molding condition setting unit for setting molding conditions is attached to a molding machine such as an injection molding machine or a die casting machine. Prior to operation of the molding machine, it is necessary to operate the molding condition setting unit to enter necessary molding conditions in accordance with a molded product. However, since the molding conditions of the molding machine cover a wide range, skill is required for setting the molding conditions so that it is difficult for a non-skilled person to efficiently perform setting work for all required setting items. In order to ease the difficulty of such molding condition setting work, there have been heretofore proposed various molding condition setting units which are added with a contrivance for simplifying operation for setting molding conditions and a contrivance for preventing setting values from being forgotten to change (for example, see Patent Literatures 1, 2 and 3).

### CITATION LIST

### Patent Literature

Patent Literature 1: JP-A-5-42571
Patent Literature 2: JP-A-2008-114403
Patent Literature 3: Japanese Patent No. 4094194

### SUMMARY OF INVENTION

### Technical Problem

However, the background-art molding machine is not provided with a device by which appropriateness of each molding condition (a setting value for each item) inputted by operation on the molding condition setting unit is diagnosed after the start of continuous automatic operation. Therefore, it is impossible to prevent the continuous automatic operation from being carried out under inappropriate molding conditions unless any defective product is found. For this reason, there is still room for further improvement in highly efficient production of a molded product with high quality.

That is, although there is no big difference in basic items of the molding conditions among manufacturers, there is still slight difference in functionality including naming or layout. Accordingly, even in the molding machine provided with the molding condition setting unit according to any of Patent Literatures 1 through 3, it is practically likely that inappropriate molding conditions are set by mistake or some molding conditions are forgotten to set. In addition, the molding conditions are set based on operator's own experience. Therefore, the operator may intentionally enter molding conditions different from the conditions recommended by the manufacturer according to circumstances. For such a reason, even when inappropriate molding conditions are set in the molding condition setting unit, mechanical operation of the molding machine is not impeded but the molding machine starts continuous automatic operation in accordance with an instruction from the operator and continues the continuous automatic operation unless a stop instruction is issued from the operator. Therefore, some molding conditions set in the molding condition setting unit may lead to inappropriate operation of the molding machine during the continuous automatic operation. Thus, there may arise such a disadvantage that a molded product whose quality does not reach a target quality is formed, or a target shot cycle cannot be obtained.

Incidentally, a display device is provided in a recent molding machine. The display device displays measured values of a group of sensors in a suitable form such as a graphic form or a list form. The sensors are provided in respective portions of the molding machine. Accordingly, an operator can view data displayed on the display device to check operation statuses of the respective portions of the molding machine during continuous automatic operation. In addition, the operator can also view change of the data for a plurality of shots (molding cycles) to check operation stability of the molding machine. However, the operator is usually alone in charge of operations of a plurality of molding machines. Therefore, it is actually difficult for the operator to continuously check the data displayed on the display devices of the molding machines and rapidly determine whether the change of the data for the shots is inappropriate or not.

The present invention has been accomplished in order to solve the drawback inherent in the background art. It is an object of the invention to provide a molding condition diagnostic device which diagnoses appropriateness of a preset molding condition according to a measured value detected during continuous automatic operation or operation stability of a molding machine, and which then informs an operator of a result of the diagnosis.

### Solution to Problem

In order to solve the aforementioned problem, the invention provides a first molding condition diagnostic device provided in a molding machine to determine whether a molding condition setting value is appropriate or not and inform an operator of a result of the determination, the molding machine having: a molding machine body which is provided with a mold opening/closing device and an injection device injecting a molding material into a cavity of a closed mold so that the molding machine body can repeat a predetermined molding cycle including a plurality of steps to mold a predetermined molded product; a molding condition setting unit which is operated by the operator to set a molding condition for the molding machine body; a control unit which controls driving of the molding machine body based on a molding condition reference value determined by specifications of the molding machine body and the molding condition setting value set in the molding condition setting unit; and a measurement unit which is provided in a predetermined region of the molding machine body to thereby measure and output a predetermined physical amount of the region where the measurement unit is provided; the molding condition diagnostic device including: an input portion which receives a measured value outputted from the measurement unit and the molding condition setting value set in the molding condition setting unit; a comparison portion which compares the measured value and the molding condition setting value both received by the input portion with each other; a storage portion in which a criterion for determining that the molding condition setting value is inappropriate is stored; a determination portion which determines whether a comparison result of the comparison portion satisfies the criterion stored in the storage portion or not; and a display portion which displays a specific determination message according to the measured value and the molding condition setting value compared with each other, when the determination portion determines that the comparison result of the comparison portion satisfies the criterion stored in the storage portion; wherein: the display portion is configured to be able to display various display image data selected by the operator in various display modes so that the determination message can be displayed on a display screen of the display portion when display of the determination message is selected by the operator.

As described above, in order to operate the molding machine, a necessary molding condition setting value according to a molded product is requested to be set in the molding condition setting unit attached to the molding machine. Assume that an inappropriate molding condition setting value for molding the molded product is set in the molding condition setting unit for some reason. Even in this case, the molding machine is not stopped immediately but continues continuous automatic operation. Accordingly, there may arise various troubles in the quality of the molded product and production efficiency.

On the other hand, whether the molding condition setting value set in the molding condition setting unit is inappropriate or not can be determined based on whether the measured value outputted from the measurement unit provided in each portion of the molding machine body has a specific relation to the molding condition set in the molding condition setting unit or not. The specific relation can be obtained by an experiment or simulation. In addition, operation stability of the molding machine can be determined based on whether a deviation of measured values for a plurality of shots detected during continuous automatic operation satisfies a criterion stored in advance in the storage portion or not.

Accordingly, the necessary molding condition diagnostic device having the input portion, the comparison portion, the storage portion and the determination portion is attached to the molding machine body. When the determination portion determines that the comparison result of the comparison portion satisfies the criterion stored in the storage portion, the specific determination message according to the measured value and the molding condition setting value compared with each other is outputted to the display portion. With this configuration, the operator can know that the molding condition setting value is inappropriate. Therefore, the operator can take measures corresponding to the display contents of the display portion suitably so that the molded product with high quality can be molded with high efficiency. Incidentally, for some kind of molded product, the operator may intentionally set a molding condition setting value which is different from the molding condition setting value for molding an ordinary molded product. In this case, it is therefore unnecessary to take any special measures.

In addition, the display portion is configured to be able to display various display image data selected by the operator in various display modes so that the determination message can be displayed on the display screen of the display portion when display of the determination message is selected by the operator. With this configuration, the operator can display various image data on the display screen of the display portion if occasion demands. Accordingly, it is possible to make operation of the molding machine convenient.

In order to solve the aforementioned problem, the invention provide a second molding condition diagnostic device provided in a molding machine to determine whether a molding condition setting value is appropriate or not and inform an operator of a result of the determination, the molding machine having: a molding machine body which is provided with a mold opening/closing device and an injection device injecting a molding material into a cavity of a closed mold so that the molding machine body can repeat a predetermined molding cycle including a plurality of steps to mold a predetermined molded product; a molding condition setting unit which is operated by the operator to set a molding condition for the molding machine body; a control unit which controls driving of the molding machine body based on a molding condition reference value determined by specifications of the molding machine body and the molding condition setting value set in the molding condition setting unit; and a measurement unit which is provided in a predetermined region of the molding machine body to thereby measure and output a predetermined physical amount of the region where the measurement unit is provided; the molding condition diagnostic device including: an input portion which receives a measured value outputted from the measurement unit and the molding condition reference value stored in the control unit; a comparison portion which compares the measured value and the molding condition reference value both received by the input portion with each other; a storage portion in which a criterion for determining that the molding condition setting value is inappropriate is stored; a determination portion which determines whether a comparison result of the comparison portion satisfies the criterion stored in the storage portion or not; and a display portion which displays a specific determination message according to the measured value and the molding condition reference value compared with each other, when the determination portion determines that the comparison result of the comparison portion satisfies the criterion stored in the storage portion; wherein: the display portion is configured to be able to display various display image data selected by the operator in various display modes so that the determination message can be displayed on a display screen of the display portion when display of the determination message is selected by the operator.

Relatively to the first molding condition diagnostic device having a configuration in which the measured value outputted from the measurement unit and the molding condition setting value set in the molding condition setting unit are compared with each other by the comparison portion, the second molding condition diagnostic device has a configuration in which the measured value outputted from the measurement unit and the existing molding condition reference value determined from the specifications of the molding machine are compared with each other by the comparison portion. When the molding condition setting value set in the molding condition setting unit is inappropriate, the measured value is not consistent with the molding condition reference value. Accordingly, based on the comparison between the measured value and the molding condition reference value, it is possible to determine whether the molding condition setting value is appropriate or inappropriate. Accordingly, when the determination portion determines that the comparison result of the comparison portion satisfies the criterion stored in the storage portion, the specific determination message according to the measured value and the molding condition reference value compared with each other is outputted to the display portion. In this manner, the second molding condition diagnostic device can exert the same effect as the first molding condition diagnostic device.

In addition, the invention provides a molding condition diagnostic device according to the first configuration, wherein: one selected from diagnosis items as a diagnosis item for the molding condition setting value to be determined by the determination portion is set in advance in the control unit, the diagnosis items at least including: primary pressure, the number of injection stages, dwelling velocity, the number of dwelling stages, injection execution torque, and a cushion amount in an injection step; the number of plasticization stages, a plasticization time, metering density stabilization, a metering start position, a metering time, and metering execution torque in a plasticization step; the number of mold closing stages, the number of mold opening stages, low-pressure mold clamping force, an intermediate timer time, a gate cutting start position, and load torque of a mold opening/closing motor in a mold opening/closing step; the number of eject stages and load torque of an eject motor in an eject step; a forcible stop time in an air blowing step; mold clamping force in a mold clamping step; a display item and a determination item displayed on the display portion; and continuous defective product setting and molding condition storage set in the molding condition setting unit; and the control unit can control the determination portion to automatically execute determination about each of the diagnosis items.

For each of the aforementioned diagnosis items, the molding condition setting value set in the molding condition setting unit is compared with the measured value outputted from the measurement unit. Thus, it is possible to determine whether the molding condition setting value is appropriate or not.

In addition, the invention provides a molding condition diagnostic device according to the second configuration, wherein: diagnosis items for molding condition setting values to be determined by the determination portion are set in advance in the control unit, the diagnosis items at least including: a dwelling time, injection load torque and a filling rate in an injection step; a suck-back amount and metering load torque in a metering step; an electric conduction rate into a heating cylinder heater during temperature adjustment of a heating cylinder and during molding operation; and the control unit controls the determination portion to automatically execute determination about each of the diagnosis items.

For each of the aforementioned diagnosis items, the molding condition reference value determined based on the specifications of the molding machine body is compared with the measured value outputted from the measurement unit. Thus, it is possible to determine whether the molding condition setting value is appropriate or not.

In addition, the invention provides a molding condition diagnostic device according to the first and second configurations, wherein: when an instruction to perform molding condition diagnosis is issued from the operator during continuous automatic operation, the control unit samples the measured values for a preset number of shots and controls the determination portion to automatically execute determination about each of all preset diagnosis items based on the sampled measured values.

According to the configuration, whether the molding condition setting value is appropriate or not can be diagnosed at any time during the continuous automatic operation. Accordingly, it is possible to prevent the continuous automatic operation from being continued for a long time under an inappropriate molding condition setting value. It is therefore possible to manufacture the molded product with high quality and with high efficiency. In addition, molding condition diagnosis is performed during the continuous automatic operation. Accordingly, a time only for the molding condition diagnosis is not required but it is possible to keep the productivity equivalent to that according to the background-art molding machine which does not perform molding condition diagnosis. Further, determination is made on the measured values for the preset number of shots. Accordingly, it is possible to perform accurate determination on the measured values from which fluctuation etc. has been removed.

In addition, the invention provides a molding condition diagnostic device according to the aforementioned configuration, wherein: the determination portion determines whether a deviation of the sampled measured values for the preset number of shots is larger than a deviation reference value stored in the storage portion or not, and the control unit outputs a specific determination display according to the kind of the measured values to the display portion when the determination portion determines that the deviation of the measured values for the preset number of shots is larger than the deviation reference value stored in the storage portion.

According to the configuration, it is possible to determine operation stability of the molding machine during continuous automatic operation. Accordingly, it is possible to guarantee the molded product with uniform quality.

In addition, the invention provides a molding condition diagnostic device according to the aforementioned configuration, wherein: the diagnosis items including an injection time and injection pressure in an injection step, a plasticization time in a plasticization step, nozzle temperature during molding operation, and a mold opening time, a mold closing time and a product ejecting time in a mold opening/closing step are set in advance in the control unit, and the control unit controls the determination portion to automatically execute determination about each of the diagnosis items.

For each of the aforementioned diagnosis items, an inappropriate molding condition setting value set in the molding condition setting unit leads particularly to large fluctuation. Accordingly, when a deviation of the measured values for the plurality of shots is compared with a determination value, it is possible to determine whether the molding condition setting value is appropriate or not.

### Advantageous Effects of Invention

The molding condition diagnostic device according to the invention diagnoses appropriateness of a molding condition setting value set in the molding condition setting unit. Accordingly, it is possible to prevent continuous automatic operation from being continued under an inappropriate molding condition setting value so that it is possible to manufacture a molded product with high and uniform quality and with high efficiency.

### BRIEF DESCRIPTION OF DRAWINGS

FIG. 1 A block diagram showing the configuration of a molding condition diagnostic device according to an embodiment, and the configuration of a molding machine provided with the molding condition diagnostic device.

FIG. 2 A view of the configuration of a control unit relevant to the molding condition diagnostic device.

FIG. 3 An explanatory view of a menu screen displayed on a display portion.

FIG. 4 An explanatory view of a motor load torque screen displayed on the display portion.

FIG. 5 An explanatory view of a molding condition diagnostic screen displayed on the display portion.

FIG. 6 A chart showing an operation flow of the molding condition diagnostic device.

FIG. 7 A view of a table showing items, criterions, determination messages and comments for molding condition diagnosis performed in an injection step.

FIG. 8 An explanatory view of control diagnosis of primary pressure.

FIG. 9 An explanatory view of control diagnosis of the number of injection stages.

FIG. 10 An explanatory view of control diagnosis of dwelling velocity.

FIG. 11 An explanatory view of setting value diagnosis of the dwelling velocity.

FIG. 12 An explanatory view of measured value diagnosis of the dwelling velocity.

FIG. 13 An explanatory view of measured value diagnosis of a primary injection timer.

FIG. 14 An explanatory view of measured value diagnosis of a dwelling time.

FIG. 15 An explanatory view of control diagnosis of injection execution torque.

FIG. 16 An explanatory view of control diagnosis of injection load torque.

FIG. 17 An explanatory view of measured value diagnosis of a cushion amount.

FIG. 18 An explanatory view of measured value diagnosis of primary pressure.

FIG. 19 An explanatory view of stability diagnosis of an injection time.

FIG. 20A view of a table showing items, criterions, determination messages and comments for molding condition diagnosis performed in a plasticization step.

FIG. 21 An explanatory view of measured value diagnosis of a plasticization step time.

FIG. 22 An explanatory view of measured value diagnosis of a metering start position.

FIG. 23 An explanatory view of setting value diagnosis of a metering time.

FIG. 24 An explanatory view of measured value diagnosis of suck-back.

FIG. 25 An explanatory view of control diagnosis of metering execution torque.

FIG. 26 An explanatory view of measured value diagnosis of each electric conduction rate.

FIG. 27 An explanatory view of stability diagnosis of nozzle temperature.

FIG. 28A view of a table showing items, criterions, determination messages and comments for molding condition diagnosis performed in a mold opening/closing step.

FIG. 29 An explanatory view of setting value diagnosis of low-pressure mold clamping.

FIG. 30 An explanatory view of control diagnosis of gate cutting.

FIG. 31 An explanatory view of measured value diagnosis of the low-pressure mold clamping.

FIG. 32A view of a table showing items, criterions, determination messages and comments for molding condition diagnosis performed in other steps.

FIG. 33 An explanatory view of measured value diagnosis of mold clamping force.

FIG. 34 An explanatory view of control diagnosis of the mold clamping force.

FIG. 35 An explanatory view of setting value diagnosis of monitor items.

FIG. 36 An explanatory view of setting value diagnosis of monitor determination.

FIG. 37 An explanatory view of setting value diagnosis of continuous defective product setting.

FIG. 38 An explanatory view of setting value diagnosis of molding condition storage.

FIG. 39 An explanatory view of stability diagnosis of a plasticization time.

### DESCRIPTION OF EMBODIMENT

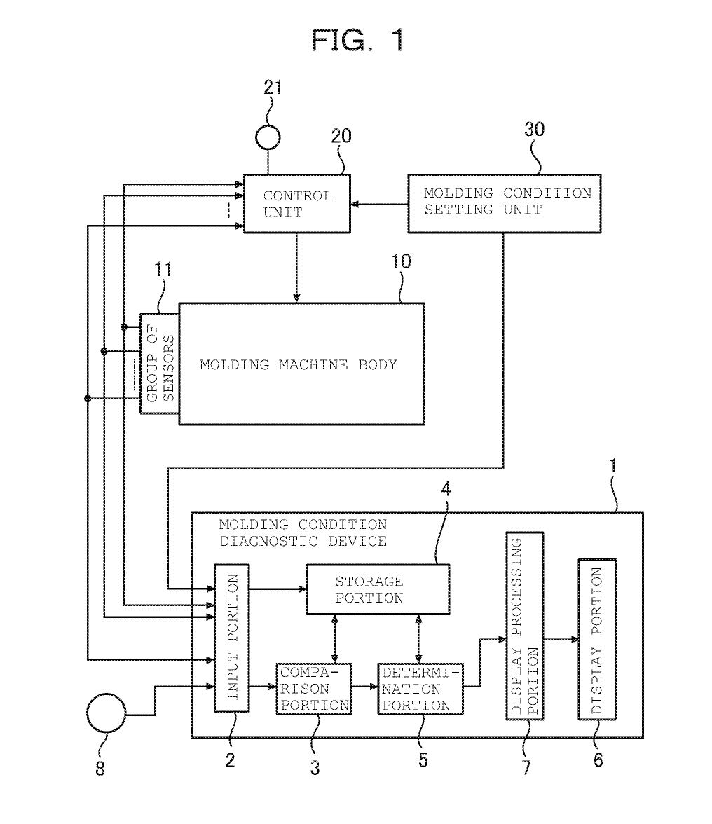

An embodiment of a molding condition diagnostic device according to the invention will be described below with reference to the drawings. As shown in FIG. 1, a molding condition diagnostic device 1 according to the embodiment is attached to a molding machine including a molding machine body 10, a control unit 20, and a molding condition setting unit 30. The molding condition diagnostic device 1 diagnoses appropriateness of each molding condition setting value set in the molding condition setting unit 30 according to each of measured values of a group of sensors and specifications of the molding machine.

The molding machine body 10 is provided with a mold opening/closing device and an injection device which injects a molding material into a closed mold so that the molding machine body 10 can repeat a predetermined molding cycle including a metering step, a mold closing step, an injection step, a mold opening step and a product ejecting step etc., to thereby mold a predetermined molded product. The molding machine body 10 may be either of an injection molding machine which molds a plastics product and a die casting machine which molds a light metal product. A measurement unit (group of sensors) 11 for detecting and outputting predetermined measured values is provided in a predetermined region of the opening/closing device and the injection device. The measured values of the group of sensors 11 are inputted to the molding condition diagnostic device 1 and the control unit 20. Incidentally, since the configuration of the molding machine body 10 is not the gist of the invention but a matter belonging to public knowledge, more detailed description thereof will be omitted here.

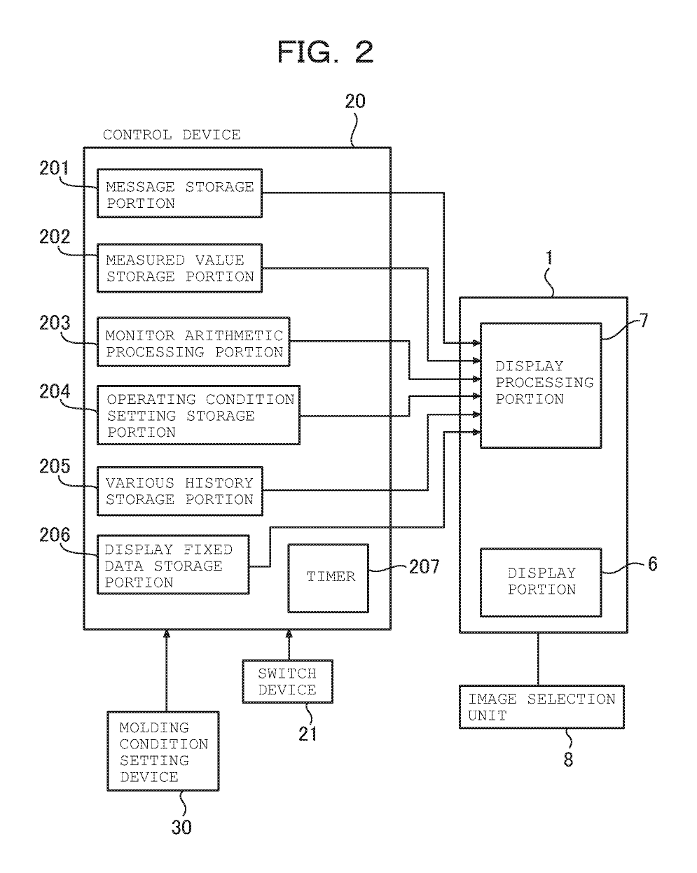

The control unit 20 takes in charge of overall driving of the molding machine including the molding machine diagnostic device 1, the molding machine body 10 and the molding condition setting unit 30. The control unit 20 controls driving of the mold opening/closing device and the injection device based on each of molding condition setting values set in the molding condition setting unit 30, each of molding condition reference values determined based on the specifications of the molding machine body 10 and each of the measured values of the group of sensors 11, to thereby execute the aforementioned predetermined molding cycle. As shown in FIG. 1, a switch device 21 for switching between start-up and stop of the molding machine is attached to the control unit 20. Incidentally, the configuration of the control unit 20 relevant to the molding condition diagnostic device 1 will be described later with reference to FIG. 2.

Before the molding machine body 10 starts to operate, an operator may input, to the molding condition setting unit 30, each of appropriate molding condition setting values consistent with characteristics of a molded product to be molded. For example, any molding condition setting unit belonging to public knowledge, such as those described in Patent Literatures 1, 2 and 3 can be used as the molding condition setting unit 30. Molding conditions which should be set in the molding condition setting unit 30 cover a wide range. Examples of the molding conditions include: primary pressure, the number of injection stages, dwelling velocity, the number of dwelling stages, injection execution torque, a cushion amount, a dwelling time, injection load torque, and a filling rate in an injection step; the number of plasticization stages, a plasticization time, metering density stabilization, a metering start position, a metering time, metering execution torque, a suck-back amount, and metering load torque in a plasticization step (metering step); the number of mold closing stages, the number of mold opening stages, low-pressure mold clamping force, an intermediate timer time, a gate cutting start position, and load torque of a mold opening/closing motor in a mold opening/closing step; the number of eject stages and load torque of an eject motor in an ejecting step; a forcible stop time in an air blowing step; mold clamping force in a mold clamping step; display items and determination items displayed on the display portion; continuous defective product setting and molding condition storage set in the molding condition setting unit; and electric conduction rates into heating cylinder heaters during temperature adjustment of heating cylinders and during molding operation, etc.

As shown in FIG. 1, the molding condition diagnostic device 1 according to the embodiment has an input portion 2, a comparison portion 3, a storage portion 4, a determination portion 5, a display portion 6, a display processing portion 7, and an image selection unit 8. The input portion 2 imports data such as each of measured values of the group of sensors 11, each of molding condition reference values stored in the control unit 20, each of molding condition setting values set in the molding condition setting unit 30, etc. The comparison unit 3 compares the measured value with the molding condition reference value or compares the measured value with the molding condition setting value. An operating program of the molding condition diagnostic device 1, each diagnosis item, each criterion for determining that the molding condition setting value is inappropriate, etc. are stored in the storage portion 4. The determination portion 5 determines whether the comparison result of the comparison portion 3 satisfies the criterion stored in the storage portion 4 or not. The display portion 6 displays required image data. The display processing portion 7 outputs the required image data to the display portion 6. The image selection unit 8 performs start-up/stop of the molding condition diagnostic device 1 and selection of image data to be displayed on the display portion 6. Incidentally, the molding condition diagnostic device 1 may be configured integrally with the aforementioned control unit 20 and the aforementioned molding condition setting unit 30.

As shown in FIG. 2, a message storage portion 201, a measured value storage portion 202, a monitor arithmetic processing portion 203, an operating condition setting storage portion 204, a various history storage portion 205, and a display fixed data storage portion 206 are provided in the control unit 20. The message storage portion 201 stores determination messages in connection with the display processing portion 7 provided in the molding condition diagnostic device 1. The measured values of the group of sensors for a predetermined number of shots during continuous automatic operation are imported into the measured value storage portion 202. The monitor arithmetic processing portion 203 applies statistic arithmetic processing to pieces of data of a large number of shots stored in the measured value storage portion 202, and holds processing results of the pieces of data. The operating condition setting storage portion 204 stores operating conditions of the respective steps for injection molding rewritably. The various history storage portion 205 stores various history data such as a periodic inspection history, an alarm history etc. The display fixed data storage portion 206 stores required data such as texts, figures, ruled lines etc. in images to be displayed on the display portion 6. In addition, a monitoring timer 207 is built in the control unit 20.

Mode type-based image calling keys for calling various mode images are provided in the image selection unit 8. When an operator operates a desired image calling key, the display processing portion 7 generates a designated image and displays the generated designated image on a display screen of the display portion 6. That is, in accordance with a push operation performed on the image calling key by the operator, the display processing portion 7 suitably reads required data from the aforementioned message storage portion 201, the aforementioned measured value storage portion 202, the aforementioned monitor arithmetic processing portion 203, the aforementioned operating condition setting storage portion 204, the aforementioned various history storage portion 205, and the aforementioned display fixed data storage portion 206, etc. In accordance with an image generating program created in advance, the display processing portion 7 generates each of the various mode images from the read required data and displays the generated mode image on the display portion 6.

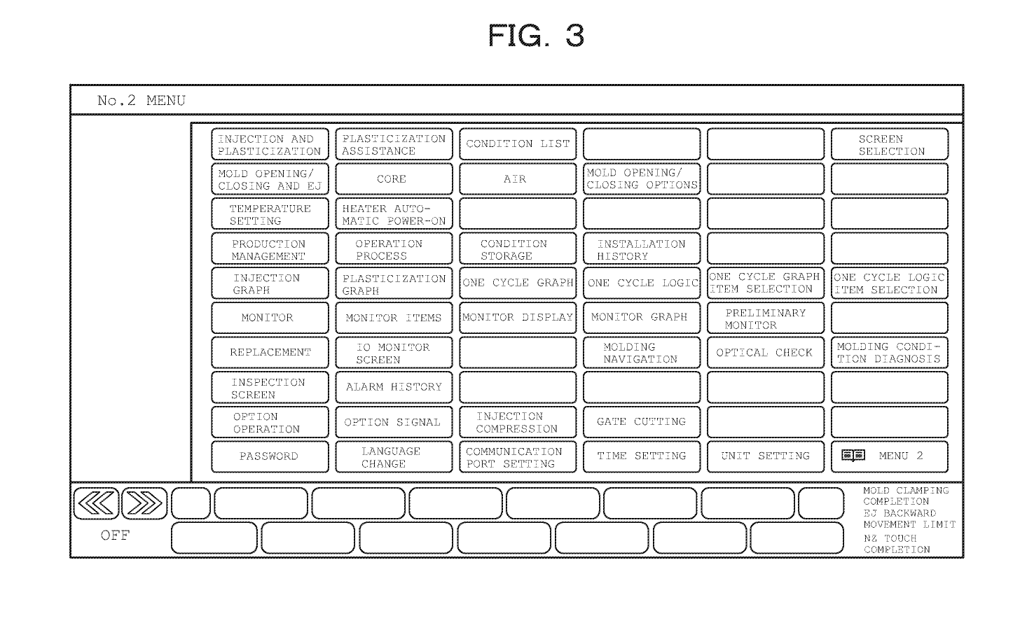

An example of a screen selectively displayed on the display portion 6 in accordance with a push operation on the image selection unit 8 will be shown in each of FIGS. 3 to 5. FIG. 3 is a menu screen appearing when the molding machine body 10 is started up. Items “Injection and Plasticization”, “Mold Opening/Closing and EJ (Eject)”, “Temperature Setting”, “Production Management”, “Graph”, “Monitor”, “Setup”, “Inspection”, “Option Operation”, and “System Setting” are provided in the display portion 6. A required image calling key for each item can be selected and displayed in a push button mode so that respective image calling keys for “Injection and Plasticization”, “Plasticization Assistance”, “Condition List”, and “Screen Selection” can be displayed on the right side of “Injection and Plasticization”. The operator selects a suitable image calling key displayed on the display portion 6, so that a desired image can be displayed on the display portion 6. In this manner, the operator can input required data and/or check the data.

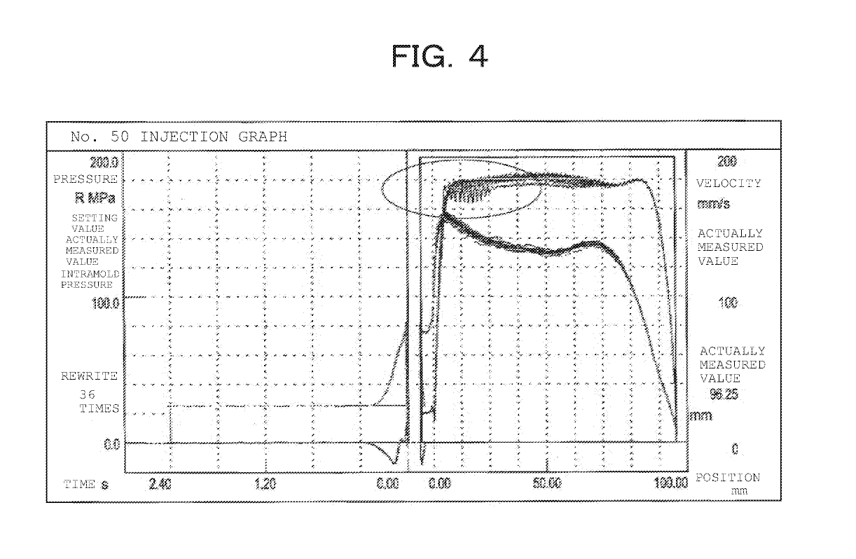

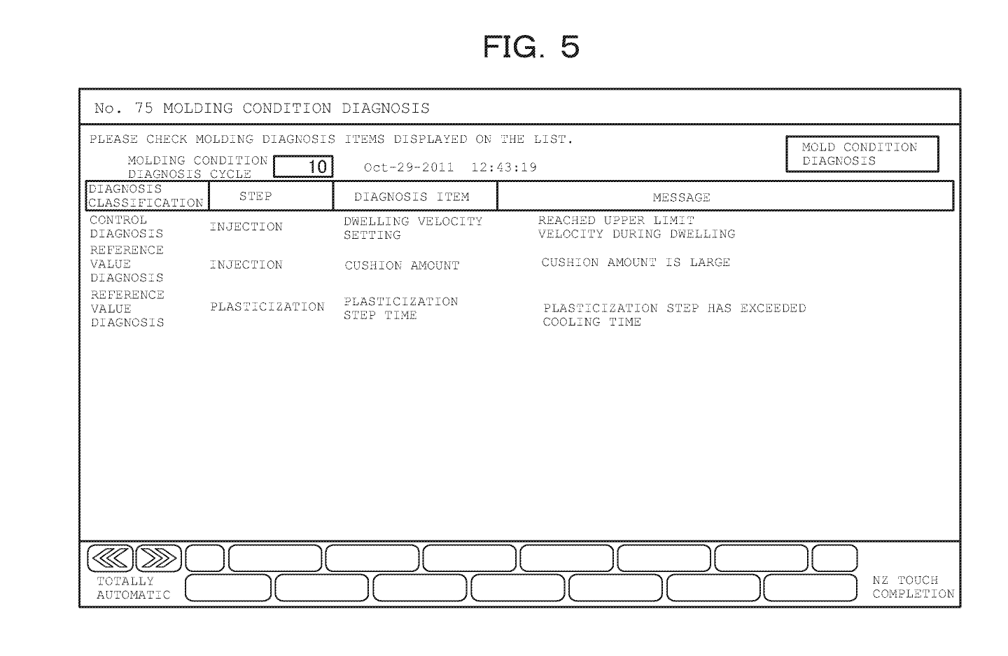

When “Injection Graph” is selected from the image calling keys displayed on the display screen in FIG. 3, data about “Motor Load Torque” exemplified in FIG. 4 are displayed as a graph on the display portion 6. In addition, assume that “Molding Condition Diagnosis” has been selected from the image calling keys displayed on the display screen in FIG. 3. In this case, when it is concluded as a result of diagnosis that inappropriate molding conditions have been set, fields “Diagnosis Classification”, “Step Name”, “Diagnosis Item”, and “Determination Message” for each diagnosis item on which it is concluded that an inappropriate molding condition has been set are displayed by text, as shown in FIG. 5. Thus, a required image can be displayed in a required mode when one is selected from the image calling keys displayed on the menu screen.

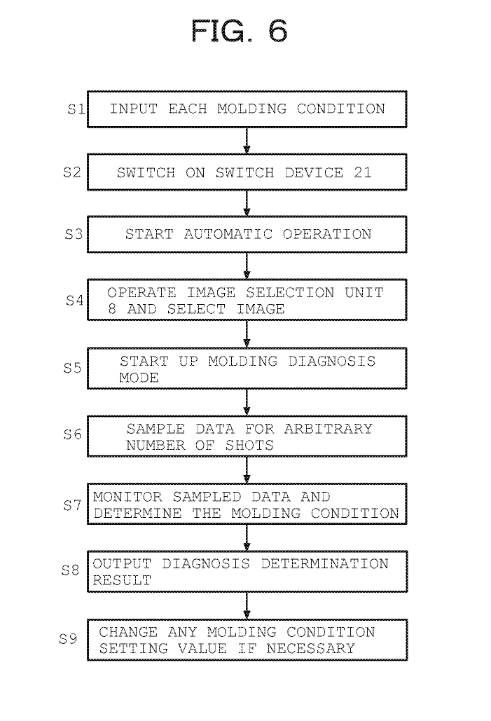

FIG. 6 shows an operation flow of the molding condition diagnostic device 1. As shown in FIG. 6, when the operator operates the switch device 21 (step S2) after required molding condition setting values have been set in the molding condition setting unit 30 (step S1), the control unit 20 is started up so that continuous automatic operation of the molding machine body 10 can be started (step S3). In a state in which the operator has not started up the molding diagnostic device 1 yet, various measured values during continuous automatic operation or data subjected to statistic arithmetic processing by the monitor arithmetic processing portion 203 are displayed on the display portion 6. By operating the image selection unit 8, the operator can start up the molding diagnostic device 1 at any time after the start of the continuous automatic operation. When the operator operates the image selection unit 8 (step S4) to start up the molding diagnostic device 1 (step S5), measured values are sampled for a number of shots set in advance in the storage portion 4 in accordance with the operating program stored in the storage portion 4 (step S6). Then, molding condition diagnosis on each of preset diagnosis items is executed automatically by the determination portion 5 base on the sampled measured values (step S7). When it is determined that a molding condition set in the molding condition setting unit 30 is inappropriate, a required determination message is displayed on the display portion 6 (step S8). The operator can check the determination message and change any molding condition setting value if necessary (step S9). On the other hand, in spite of the contents of the determination message, the operator may judge that it is not necessary to change the molding condition setting value. In such a case, the operator may continue the continuous automatic operation as it is. As described above, in the embodiment, when the molding diagnostic device 1 is started up, molding condition diagnosis is executed based on the sampled measured values for a plurality of shots. Accordingly, highly reliable molding condition diagnosis can be performed in comparison with the case where molding condition diagnosis is executed based on measured values for one shot.

The meaning and method of the molding condition diagnosis performed by the determination portion 5 will be described below in accordance with each of diagnosis items.

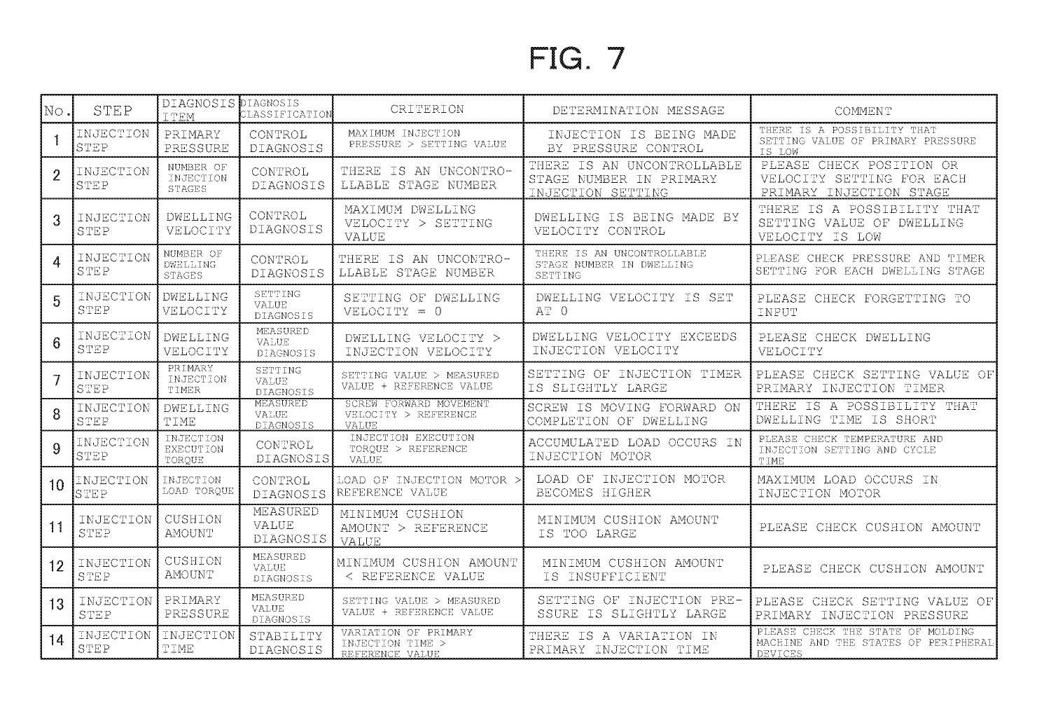

First, molding condition diagnosis performed in the injection step will be described in accordance with each of diagnosis items. As shown in FIG. 7, in the embodiment, examples of the diagnosis items in the injection step include control diagnosis of primary pressure, control diagnosis of the number of injection stages, control diagnosis of dwelling velocity, control diagnosis of the number of dwelling stages, setting value and measured value diagnosis of the dwelling velocity, setting value diagnosis of a primary injection timer, measured value diagnosis of a dwelling time, control diagnosis of injection execution torque, control diagnosis of injection load torque, measured value diagnosis of a cushion amount, measured value diagnosis of primary pressure, and stability diagnosis of an injection time.

### <Control Diagnosis of Primary Pressure>

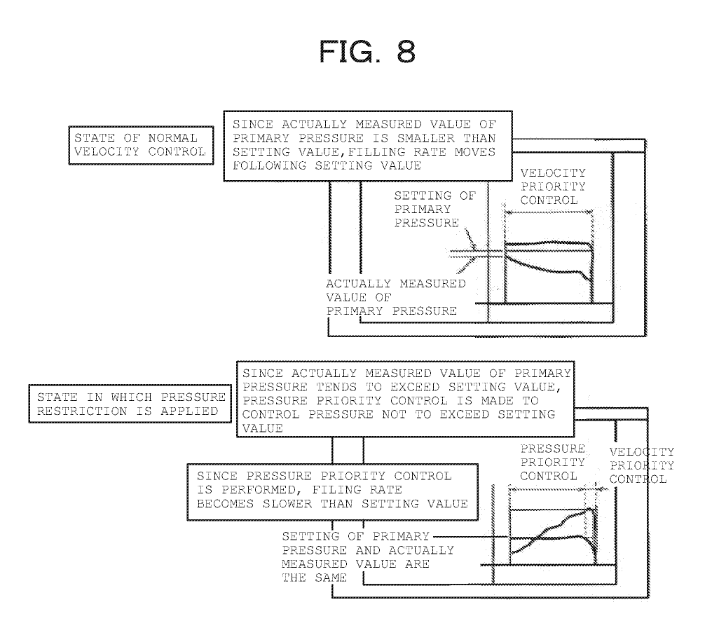

Setting of the primary pressure of the injection molding machine implies setting of pressure to be monitored. The primary pressure of the injection molding machine is set for the purpose of preventing a pressure value (maximum injection pressure) during velocity control from increasing to a setting value or higher. When setting of the primary pressure is appropriate, the maximum injection pressure is controlled by velocity priority control. As shown in FIG. 8(a), the measured value of the maximum injection pressure is always a value lower than the setting value, and the filling rate moves following the setting value. On the other hand, assume that setting of the primary pressure is too low. In this case, when the measured value is about to exceed the setting value, the maximum injection pressure is controlled by pressure priority control so that the maximum injection pressure can be prevented from exceeding the setting value. For this reason, the filling rate is slower than the setting value as shown in FIG. 8(b), to thereby cause resin clogging. Accordingly, in order to prevent the resin clogging, the operator normally sets the primary pressure at a value higher by about 10 MPa to 20 MPa than actual maximum injection pressure. On the assumption that such setting has not been performed, the maximum injection pressure may be controlled by pressure priority control when the measured value is about to exceed the setting value. Thus, in order to prevent occurrence of such a trouble, it is desirable that the operator is urged to pay attention when setting of the primary pressure is inappropriate in the light of the control mode. Therefore, in the embodiment, as shown in a first row of FIG. 7, “Measured value of maximum injection pressure is larger than setting value (Maximum Injection Pressure > Setting Value)” is stored in advance in the storage portion 4, as a criterion for determining that the molding condition setting value is inappropriate. When the measured value has exceeded the setting value, a determination message “Injection is being made by pressure control” is outputted on the display portion 6, as shown in the same row. In addition thereto, a comment “There is a possibility that setting value of primary pressure is low” is displayed on the display portion 6. To correct the molding condition in accordance with the determination message and the comment, the operator can take measures such as increasing the setting value of the primary pressure, reducing injection velocity, increasing resin temperature, etc. When pressure control is being performed intentionally according to the operator's judgment, it is unnecessary to correct the molding condition in accordance with the determination message.

### <Control Diagnosis of Number of Injection Stages>

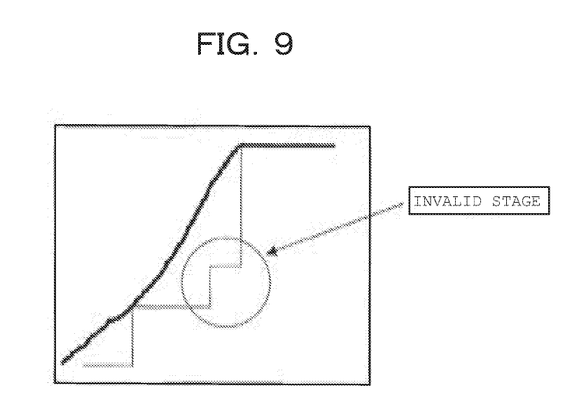

The number of control stages of injection velocity or pressure in the primary injection step can be set in the molding condition setting unit 30. Rotational velocity of an injection motor can be controlled in accordance with setting values of respective stages. However, when the number of control stages set in the molding condition setting unit 30 is inappropriate, there arises a case where the rotational velocity of the injection motor cannot be controlled in accordance with the setting values of the stages, as schematically shown in FIG. 9. There is also a fear that a control stage number at which the rotational velocity of the injection motor cannot be controlled is useless and incorrect control is executed unexpectedly. It is therefore desirable that the operator is urged to pay attention when there is such a control stage number. To this end, in the embodiment, as shown in a second row of FIG. 7, “There is a control stage number at which rotational velocity of injection motor cannot be controlled” is stored in advance in the storage portion 4, as a criterion for determining that the molding condition setting value is inappropriate. When there is a control stage number at which the rotational velocity of the injection motor is not controlled, a determination message “There is an uncontrollable stage number in primary injection setting” is outputted to the display portion 6, as shown in the same row. In addition thereto, a comment “Please check position or velocity setting for each primary injection stage” is displayed on the display portion 6. To correct the molding condition in accordance with the determination message and the comment, the operator can take measures such as deleting the portion of the invalid stage number, changing the setting value of the primary pressure at the portion of the invalid stage number, etc. The operator may neglect the determination message according to his/her own judgment.

### <Control Diagnosis of Dwelling Velocity>

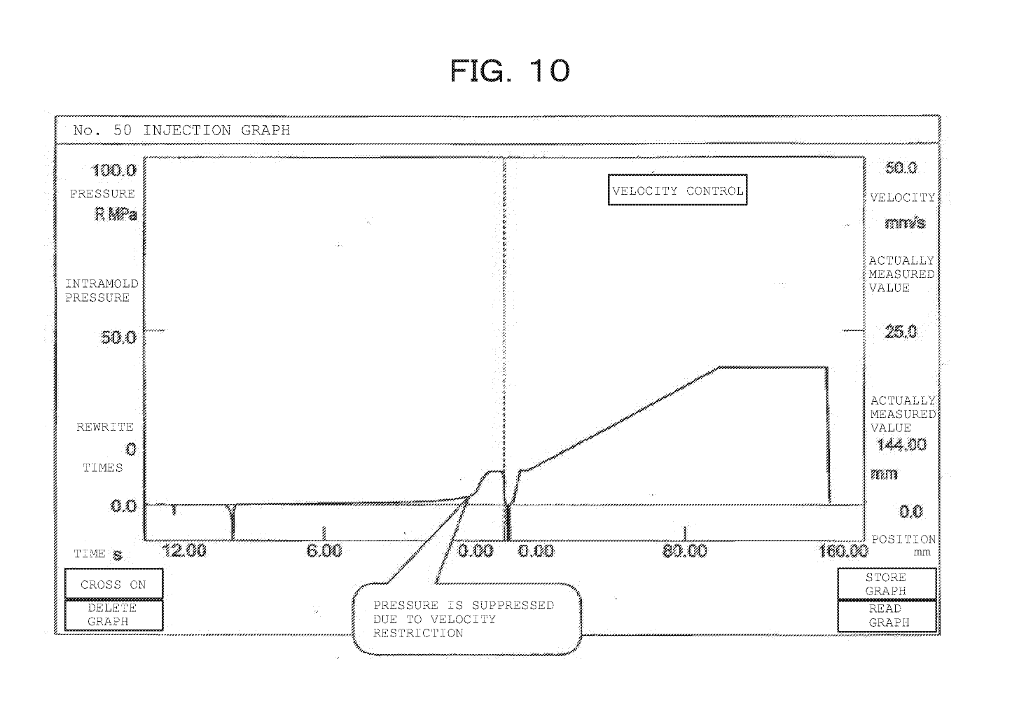

Dwelling velocity is set for the purpose of restricting the maximum velocity during dwelling so that defects such as burrs can be prevented from being generated in a molded product due to excessive velocity occurring during dwelling in a pressure control step. That is, as shown in FIG. 10, the velocity during dwelling is restricted so that pressure can be suppressed. When the setting of the dwelling velocity is appropriate, a good product can be molded. On the other hand, when the setting of the dwelling velocity is too high, a failure in appearance such as burrs may occur in a molded product. Thus, in order to prevent a defective product from being produced, it is desirable that the operator is urged to pay attention when the setting of the dwelling velocity is inappropriate in the light of the control mode. To this end, in the embodiment, as shown in a third row of FIG. 7, “Measured value of maximum dwelling velocity is larger than setting value (Maximum Dwelling Velocity > Setting Value)” is stored in advance in the storage portion 4, as a criterion for determining that the molding condition setting value is inappropriate. When the measured value has reached the setting value, a determination message “Dwelling is being made by velocity control” is outputted to the display portion 6, as shown in the same row. In addition thereto, a comment “There is a possibility that setting value of dwelling velocity is low” is displayed on the display portion 6. To correct the molding condition in accordance with the determination message and the comment, the operator can take measures such as reducing the set dwelling, raising the setting of the dwelling velocity, changing a V-P switching position, etc. The setting of the dwelling velocity may be often used intentionally by the operator under rate control. Accordingly, it can be inferred that the molding condition must be changed only if the pressure is too low to reach target pressure or the pressure is so high that excessive velocity may likely occur.

### <Control Diagnosis of Number of Dwelling Stages>

The number of control stages of dwelling can be set in the molding condition setting unit 30. Dwelling can be controlled in accordance with dwelling setting values in respective set stages. However, when the number of control stages of dwelling set in the molding condition setting unit 30 is inappropriate, there arises a case where the dwelling cannot be controlled in accordance with the dwelling setting values in the respective set stages (see FIG. 9). There is also a fear that a control stage number at which the rotational velocity of the injection motor cannot be controlled is useless and incorrect control is executed unexpectedly. It is therefore desirable that the operator is urged to pay attention when there is such a control stage number. To this end, in the embodiment, as shown in a fourth row of FIG. 7, “There is a control stage number at which dwelling force is not controlled” is stored in advance in the storage portion 4, as a criterion for determining that the molding condition setting value is inappropriate. When there is a control stage number at which the dwelling force is not controlled, a determination message “There is an uncontrollable stage number in dwelling setting” is outputted to the display portion 6, as shown in the same row. In addition thereto, a comment “Please check the pressure and timer setting for each dwelling stage” is displayed on the display portion 6. To correct the molding condition in accordance with the determination message and the comment, the operator can take measures such as deleting the portion of the invalid stage number, changing the primary pressure setting value at the portion of the invalid stage number, etc. The operator may neglect the determination message according to his/her own judgment.

### <Setting Value Diagnosis of Dwelling Velocity (Forgetting to Set Dwelling Velocity)>

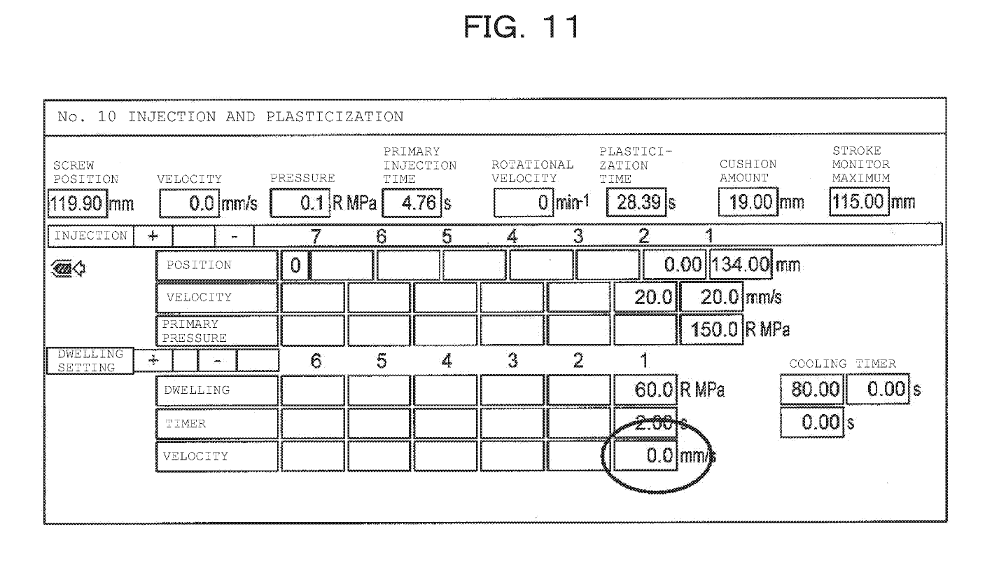

As described above, the dwelling velocity is set for the purpose of restricting the maximum velocity during dwelling so that excessive velocity can be prevented from occurring during dwelling which is a pressure control step. Accordingly, when excessively high dwelling velocity is set in the molding condition setting unit 30, product defects such as burrs are generated. On the other hand, when excessively low dwelling velocity is set or when dwelling velocity is not set as shown in FIG. 11 (dwelling velocity=0.0 mm/s), there is a disadvantage that appropriate dwelling velocity cannot be obtained so that dwelling cannot be applied to a molded product, etc. It is therefore desirable that moderate dwelling velocity is set within a range in which dwelling is not largely affected and product defects such as burrs are not generated. However, since pressure control is mostly made in the dwelling step, the operator easily forgets to set the velocity. Accordingly, it is desirable that the operator is informed of a message in such a case so that the operator can be urged to pay attention. To this end, in the embodiment, as shown in a fifth row of FIG. 7, “Dwelling Velocity=0” is stored in advance in the storage portion 4, as a criterion for determining that the molding condition setting value is inappropriate. When dwelling velocity is not set in the molding condition setting unit 30, a determination message “Dwelling velocity is 0” is outputted to the display portion 6, as shown in the same row. In addition thereto, a comment “Please check forgetting to input” is displayed on the display portion 6. To correct the molding condition in accordance with the determination message and the comment, the operator can set moderate dwelling velocity in a dwelling velocity setting field of the molding condition setting unit 30. The operator may neglect the determination message according to his/her own judgment.

### <Measured Value Diagnosis of Dwelling Velocity (Checking of Dwelling Velocity)>

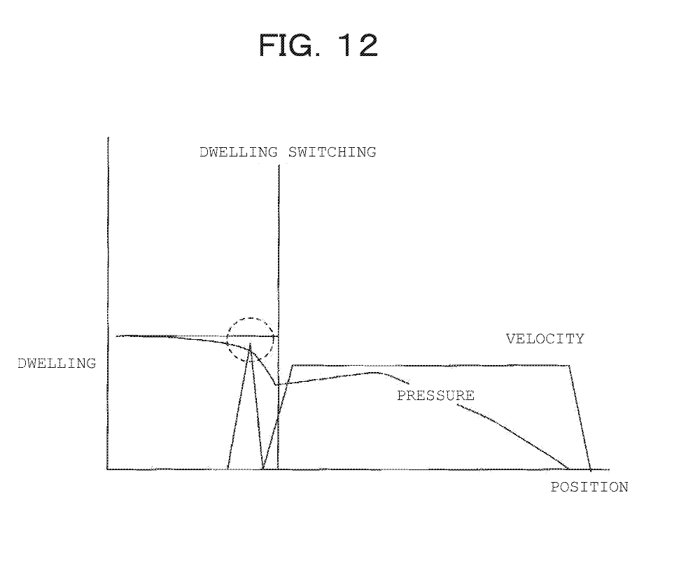

Dwelling is a step for performing filling with pressure in accordance with a contraction state of a molding material injected into a cavity. Since pressure is normally applied in a state in which the cavity is fully filled with the molding material, injection velocity often does not rise. However, when the filling amount in the primary injection step is inappropriate, velocity higher than that in the injection step occurs in the dwelling step as shown in FIG. 12, to thereby cause defects such as burrs. In order to prevent a defective product from being produced, it is therefore desirable that the operator is urged to pay attention when the dwelling velocity is inappropriate. To this end, in the embodiment, as shown in a sixth row of FIG. 7, “Dwelling velocity is higher than injection velocity (Dwelling Velocity > Injection Velocity)” is stored in advance in the storage portion 4, as a criterion for determining that the molding condition setting value is inappropriate. When the dwelling velocity exceeds the injection velocity, a determination message “Dwelling velocity exceeds injection velocity” is outputted to the display portion 6, as shown in the same row. In addition thereto, a comment “Please check dwelling velocity” is displayed on the display portion 6. To correct the molding condition in accordance with the determination message and the comment, the operator can take measures such as setting moderate dwelling velocity in a dwelling velocity setting field of the molding condition setting unit 30, adjusting the filling amount of the primary injection, etc.

### <Setting Value Diagnosis of Primary Injection Timer>

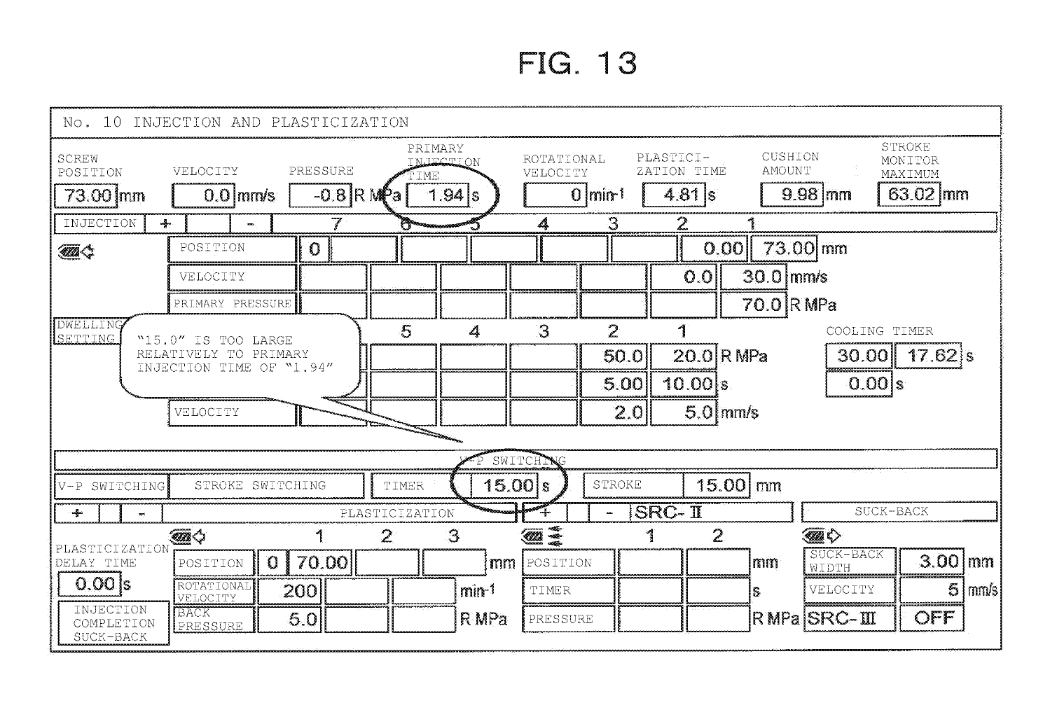

The primary injection timer implies a function as a primary injection time backup timer. The primary injection timer is set for the purpose of allowing the control unit 20 to automatically stop the molding machine body 10 due to primary injection abnormality when the primary injection time during molding exceeds a setting time of the primary injection timer. Accordingly, in the case where the setting of the primary injection timer is inappropriately longer than the primary injection time, the molding machine body 10 cannot be stopped automatically even when primary injection abnormality is generated. Therefore, this may lead to generation of a problem such as nozzle clogging. For example, such a problem is apt to be caused when 15.00 sec is set as the setting time of the primary injection timer while the measured value of the primary injection time is 1.94 sec, as shown in FIG. 13. In order to prevent a trouble from occurring, it is therefore desirable that the operator is urged to pay attention when an excessive time is set in the primary injection timer. To this end, in the embodiment, as shown in a seventh row of FIG. 7, “Setting value of primary injection timer is larger by at least reference value than measured value (Setting Value > Measured Value+Reference Value)” is stored in advance in the storage portion 4, as a criterion for determining that the molding condition setting value is inappropriate. When the setting value exceeds this value, a determination message “Setting value of injection timer is slightly large” is outputted to the display portion 6, as shown in the same row. In addition thereto, a comment “Please check setting value of primary injection timer” is displayed on the display portion 6. To correct the molding condition in accordance with the determination message and the comment, the operator corrects the primary injection timer to a value which is larger by about 0.5 sec to 1.0 sec than the measured value. When the timer switching method is set as the V-P switching method, it is unnecessary to correct the molding condition in accordance with the determination message.

### <Measured Value Diagnosis of Dwelling Time>

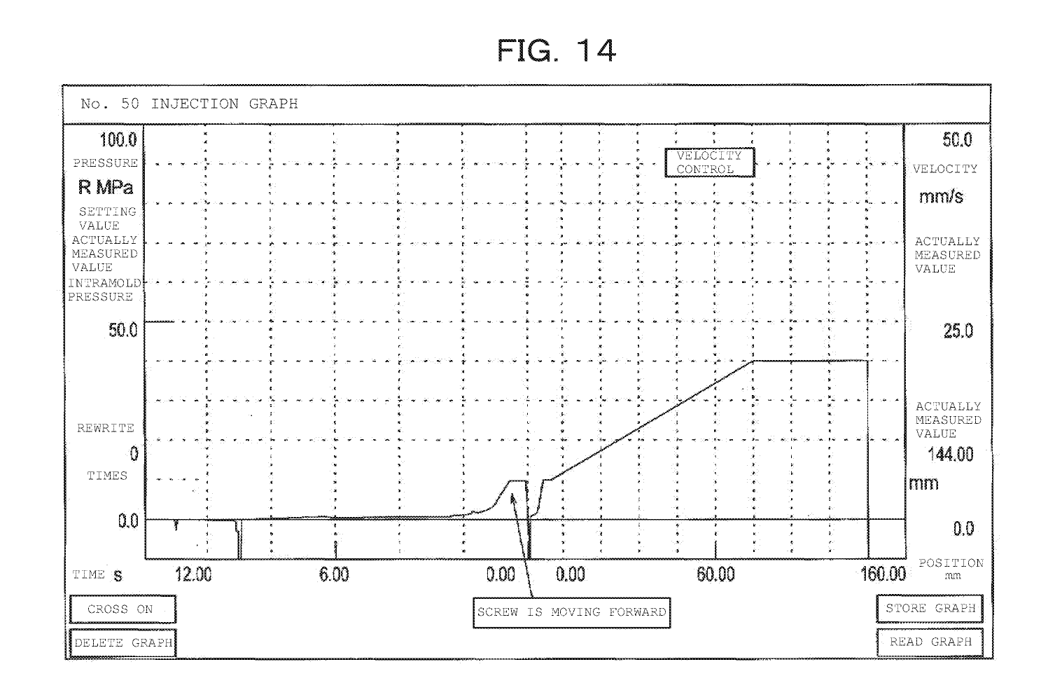

The dwelling time is an item for setting a time (gate seal time) in which a gate portion is solidified so that a sprue and a runner can be ejected. The gate seal time is determined based on the specifications of the molding machine body 10 including the mold. In the description of the invention, each value determined based on the specifications of the molding machine body 10 is referred to as molding condition reference value or simply as reference value. As shown in FIG. 14, there is a possibility that the gate has not been solidified during the time when the screw is moving forward continuously in an end stage of the dwelling step. When the dwelling time is set during the time when the screw is moving forward continuously, it is impossible to eject a molded product excellently. In order to prevent a problem from occurring, it is therefore desirable that the operator is urged to pay attention when an inappropriate time is set as the dwelling time. To this end, in the embodiment, as shown in an eighth row of FIG. 7, “Screw is moving forward at velocity higher than reference value (Screw Forward Movement Velocity > Reference Value) on completion of dwelling” is stored in advance in the storage portion 4, as a criterion for determining that the molding condition setting value is inappropriate. When the screw is moving forward at the velocity higher than the reference value on completion of the dwelling, a determination message “Screw is moving forward on completion of dwelling” is outputted to the display portion 6, as shown in the same row. In addition thereto, a comment “There is a possibility that dwelling time is short” is displayed on the display portion 6. To correct the molding condition in accordance with the determination message and the comment, the operator can prolong the dwelling setting time.

### <Control Diagnosis of Injection Execution Torque>

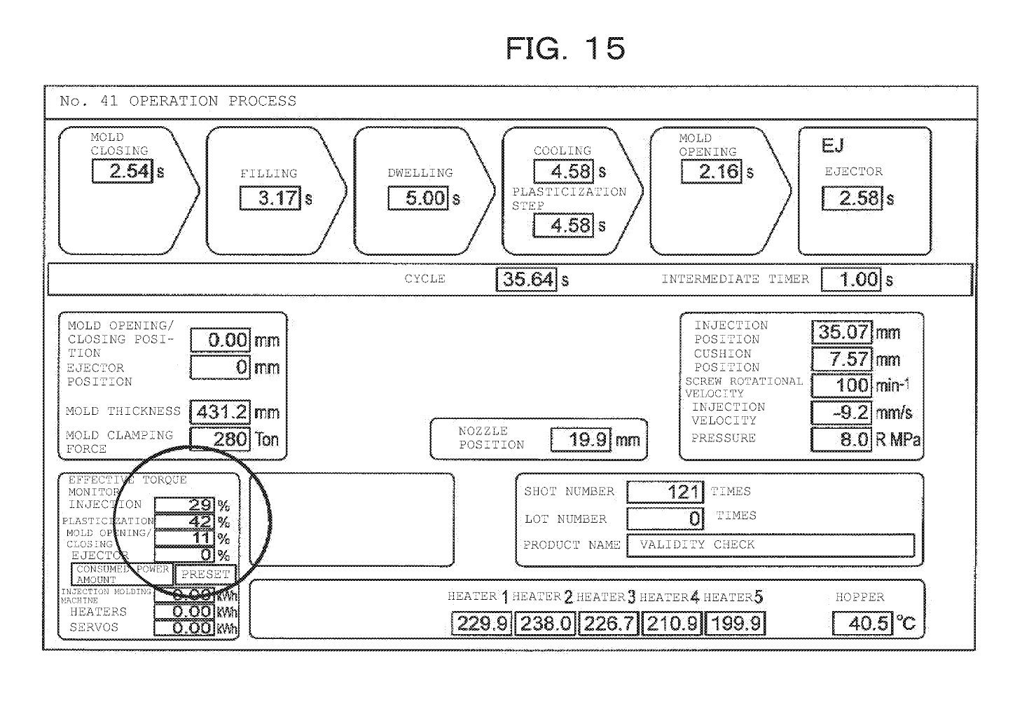

Injection execution torque is torque which is accumulated in the injection motor when a load of the injection motor has been carried over to a next cycle. When the molding condition is appropriate, the driving time of the injection motor in one cycle is short. Accordingly, there is a margin in recovery time of the injection motor so that injection execution torque is not accumulated in the injection motor. However, when, for example, cooling time is extremely short relatively to the injection and dwelling time, the injection motor cannot be recovered every cycle so that injection execution torque has to be accumulated in the injection motor to thereby eventually lead to occurrence of an overload, as shown in FIG. 15. Incidentally, the injection execution torque is also a reference value determined based on the specifications of the molding machine body 10. Thus, in order to avoid stop of the molding machine, it is desirable that the operator is urged to pay attention when the injection execution torque is accumulated in the injection motor. To this end, in the embodiment, as shown in a ninth row of FIG. 7, “Measured value of injection execution torque is larger than 0% (Injection Execution Torque > Reference Value)” is stored in advance in the storage portion 4, as a criterion for determining that the molding condition setting value is inappropriate. When the measured value of the injection execution torque exceeds the reference value, a determination message “Accumulated load occurs in injection motor” is outputted to the display portion 6, as shown in the same row. In addition thereto, a comment “Please check temperature and injection setting and cycle time” is displayed on the display portion 6. To correct the molding condition in accordance with the determination message and the comment, the operator can take measures such as prolonging the cooling time, reducing the injection pressure, etc.

### <Control Diagnosis of Injection Load Torque>

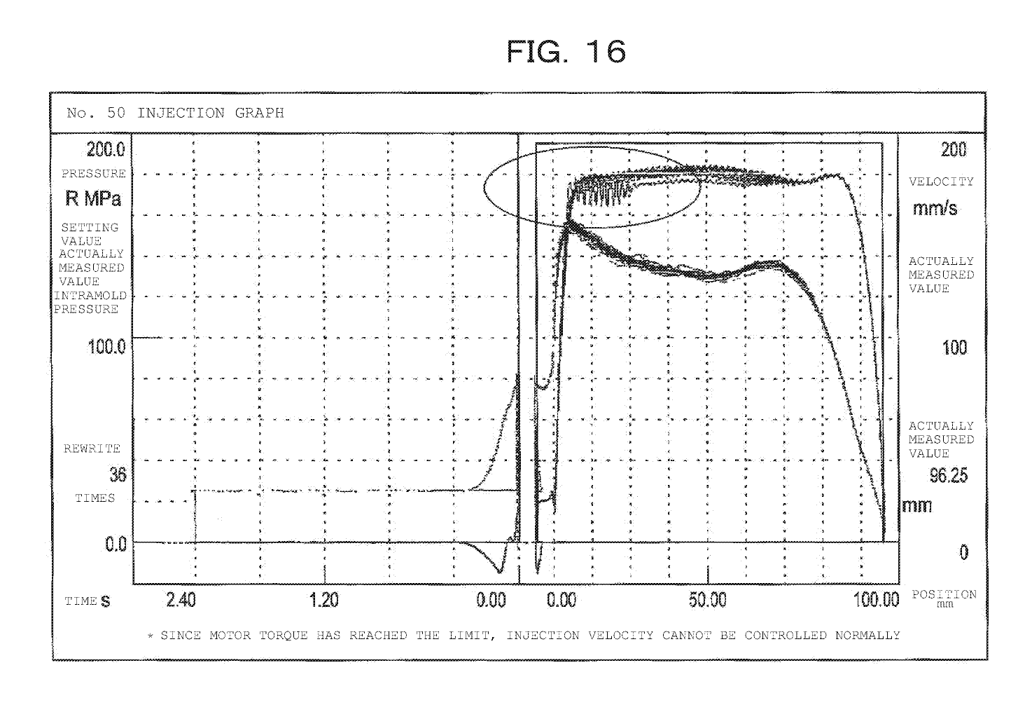

Injection load torque is a load of the injection motor in the injection step. When a predetermined time elapses after the injection load torque reaches the maximum, the molding machine body 10 stops due to an “injection motor overload error”. In addition, it may be also assumed that when the load torque of the injection motor reaches the maximum, the injection motor becomes unstable to be controlled, as shown in FIG. 16. In order to prevent the molding machine from stopping, it is therefore desirable that the operator is urged to pay attention when the injection load torque becomes higher. To this end, in the embodiment, as shown in a tenth row of FIG. 7, “Measured value of injection load torque is larger than reference value (Injection Load Torque > Reference Value)” is stored in advance in the storage portion 4, as a criterion for determining that the molding condition setting value is inappropriate. When the measured value of the injection load torque exceeds the reference value, a determination message “Load of injection motor becomes higher” is outputted to the display portion 6, as shown in the same row. In addition thereto, a comment “Maximum load occurs in injection motor” is displayed on the display portion 6. To correct the molding condition in accordance with the determination message and the comment, the operator can reset the molding condition in a direction to reduce the load of the injection motor.

### <Measured Value Diagnosis of Cushion Amount>

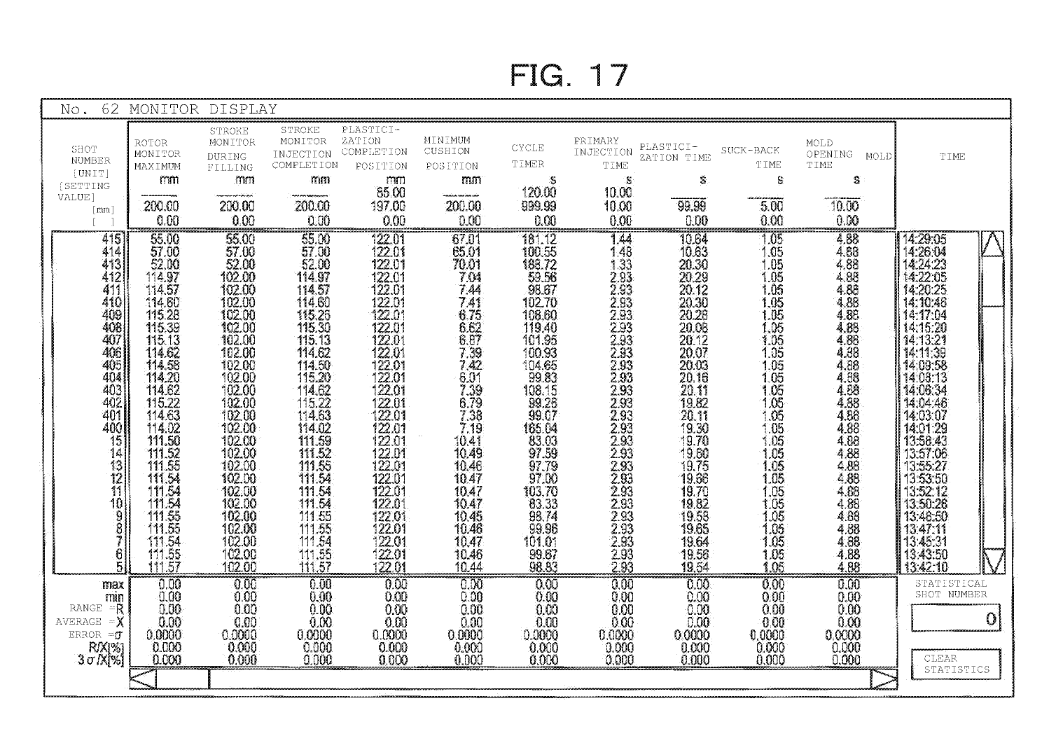

A cushion amount in injection molding means a resin amount left in a front portion of the screw when filling is completed. As shown in FIG. 17, the cushion amount is displayed on the display portion 6 to be a residual stroke relative to a forward movement limit of the screw. The cushion amount plays a role of transmitting velocity and pressure in the injection step and the dwelling step. When the cushion amount is too large, there arises a problem that pressure transmission becomes poor or a large amount of resin left in the cushion portion is filled into the cavity in a next step to degrade homogeneity of a molded product, etc. On the other hand, when the cushion amount is “0”, there arises a problem that pressure is not applied in the dwelling step. When the cushion amount is inappropriate in this manner, the cushion amount affects molding of a good product largely. It is therefore desirable that the operator is urged to pay attention. To this end, in the embodiment, as shown in an eleventh row and a twelfth row of FIG. 7, “Cushion Amount > Reference Value” and “Cushion Amount < Reference Value” are stored in advance in the storage portion 4, as criterions for determining that the cushion amount is inappropriate. When the cushion amount is excessively large, a determination message “Minimum cushion amount is too large” is outputted to the display portion 6 and a comment “Please check cushion amount” is displayed on the display portion 6, as shown in the eleventh row of FIG. 7. On the other hand, when the cushion amount is excessively small, a determination message “Minimum cushion amount is insufficient” is outputted to the display portion 6 and a comment “Please check cushion amount” is displayed on the display portion 6, as shown in the twelfth row of FIG. 7. To correct the molding condition in accordance with the determination message and the comment, the operator has to correct the injection position and the metering position overall.

### <Measured Value Diagnosis of Primary Pressure>

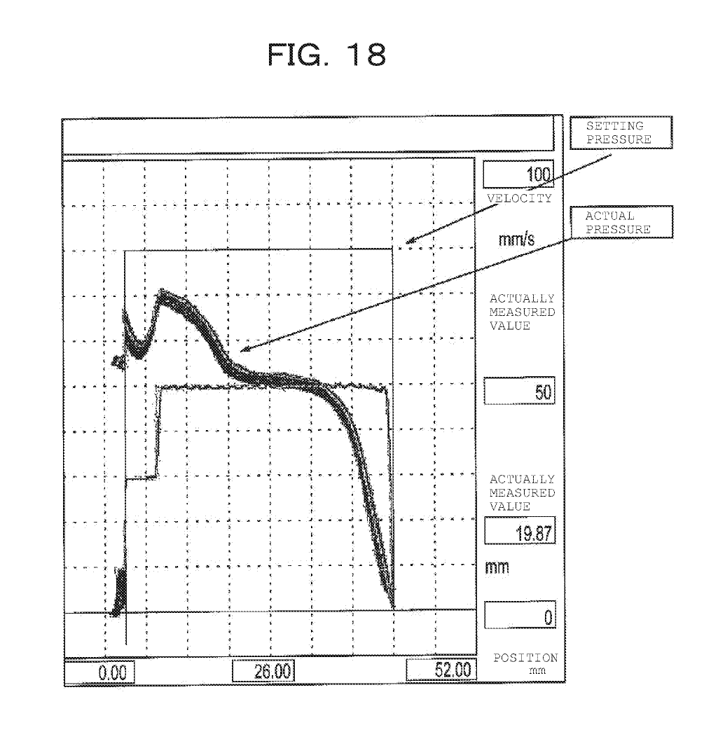

As described above, setting of the primary pressure of the injection molding machine implies setting of pressure to be monitored. The primary pressure of the injection molding machine is set for the purpose of preventing a pressure value (maximum injection pressure) during velocity control from increasing to a setting valued or higher. Therefore, it is general that a value higher by 10 MPa to 20 MPa than actual maximum injection pressure is set as the primary pressure as shown in FIG. 18, so that the maximum injection pressure in the injection step can be prevented from being controlled by pressure priority control in the injection step. However, when the setting value of the primary pressure is too high, the primary pressure monitoring function deteriorates. It is therefore desirable that the operator is urged to pay attention. To this end, in the embodiment, as shown in a thirteenth row of FIG. 7, “Setting value of primary pressure is higher than the sum of measured value of maximum injection pressure and reference value (Setting Value > Measured Value+Reference Value)” is stored in advance in the storage portion 4, as a criterion for determining that the setting value of the molding condition is inappropriate. When the setting value of the primary pressure satisfies this condition, a determination message “Setting of injection pressure is slightly large” is outputted to the display portion 6, as shown in the same row. In addition thereto, a comment “Please check setting value of primary injection pressure” is displayed on the display portion 6. To correct the molding condition in accordance with the determination message and the comment, the operator can reduce the setting value of the primary pressure. It is unnecessary to correct the molding condition when slightly large primary pressure is set according to the operator's judgment.

### <Stability Diagnosis of Primary Injection Time>

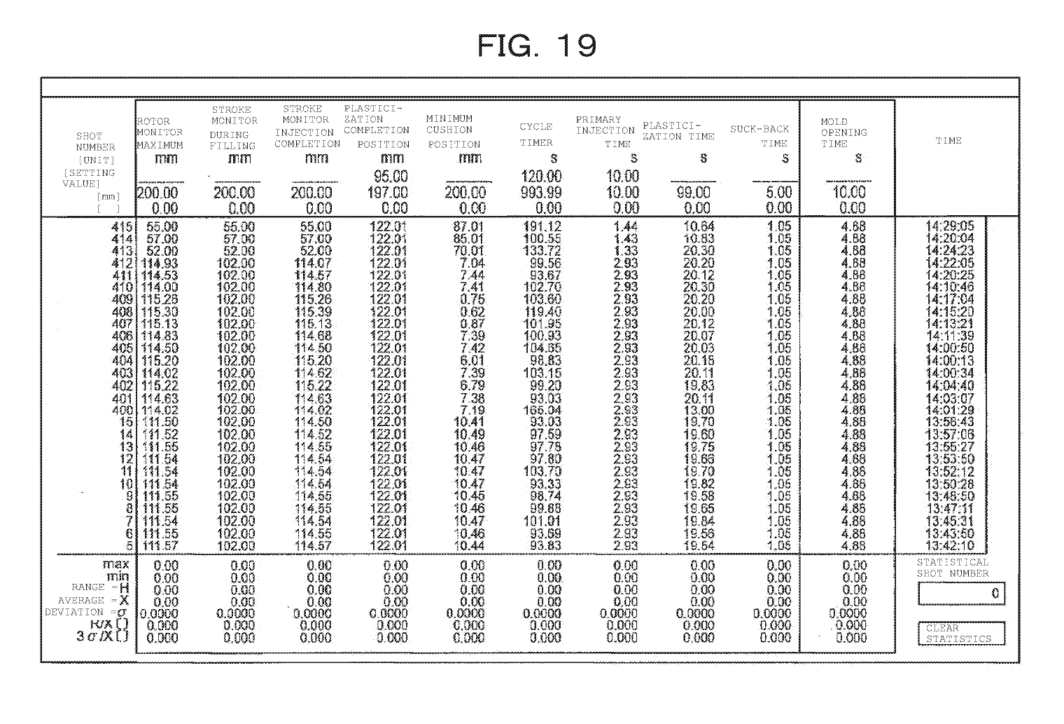

Regardless of appropriateness of the molding condition set in the molding condition setting unit 30, there appears a variation in a primary injection time in the case where there is abnormality in various servomotors provided in the molding machine body 10 or in the case where a temporal variation occurs in a step in which peripheral devices are operated. Accordingly, the variation of the primary injection time is calculated, so that occurrence of abnormality in the various servomotors or the peripheral devices can be estimated. When occurrence of abnormality in the various servomotors or the peripheral devices is estimated from the variation of the primary injection time in this manner, it is desirable that the operator is urged to pay attention in order to enable timely maintenance. To this end, in the embodiment, as shown in FIG. 19, primary injection time data for a predetermined number of shots (for example, 50 shots or 100 shots) are imported continuously into the control unit 20 and a deviation between a maximum value and a minimum value of the imported primary injection time data is obtained by the monitor arithmetic processing portion 203. As shown in a fourteenth row of FIG. 7, “Variation of Primary Injection Time > Reference Value” is stored in advance in the storage portion 4, as a criterion for determining that the molding condition setting value is inappropriate. When the obtained deviation is larger than the reference value, a determination message “There is a variation in primary injection time” is displayed on the display portion 6, as shown in the same row. In addition thereto, a comment “Please check the state of molding machine and the states of peripheral devices” is displayed on the display portion 6. Since the operator can easily recognize that there is a variation larger than the reference value in the primary injection time in this manner, the operator can take suitable measures rapidly. Accordingly, operation of the molding machine body 10 as a whole can be stabilized so that a molded product with target quality can be manufactured in a target shot cycle.

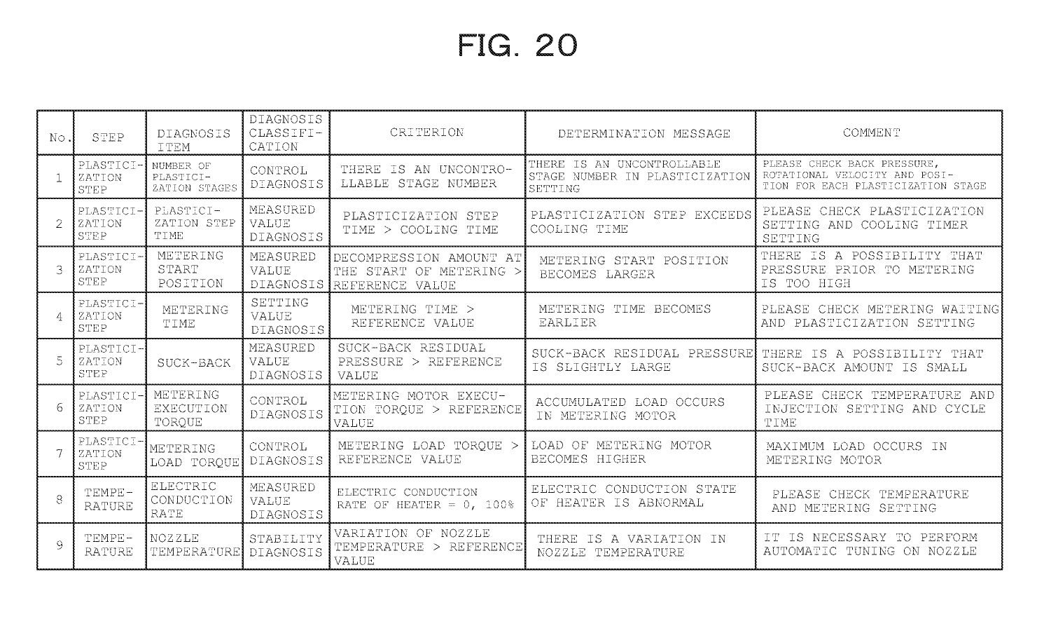

Next, molding condition diagnosis performed in the plasticization step and a temperature adjustment step will be described in accordance with diagnosis items. As shown in FIG. 20, in the embodiment, examples of the diagnosis items in the plasticization step include control diagnosis of the number of plasticization stages, measured value diagnosis of a plasticization step time, measured value diagnosis of a metering start position, setting value diagnosis of a metering time, measured value diagnosis of suck-back, control diagnosis of metering execution torque, and control diagnosis of metering load torque. In addition, examples of the diagnosis items during temperature adjustment or during molding operation include measured value diagnosis of electric conduction rates and stability diagnosis of nozzle temperature.

### <Control Diagnosis of Number of Plasticization Stages>

The number of control stages of screw rotational velocity or back pressure in the plasticization step can be set in the molding condition setting unit 30. Rotational velocity of a metering motor can be controlled in accordance with setting values of respective stages. However, when the number of control stages set in the molding condition setting unit 30 is inappropriate, there arises a case in which the rotational velocity of the metering motor cannot be controlled in accordance with the setting values of the stages (see FIG. 9) There is also a fear that a control stage number at which the rotational velocity of the metering motor cannot be controlled is useless and incorrect control is executed unexpectedly. It is therefore desirable that the operator is urged to pay attention when there is such a control stage number. To this end, in the embodiment, as shown in a first row of FIG. 20, “There is setting value at which rotational velocity of metering motor is not controlled” is stored in advance in the storage portion 4, as a criterion for determining that the molding condition setting value is inappropriate. When there is a control stage at which the rotational velocity of the metering motor is not controlled, a determination message “There is an uncontrollable stage number in plasticization setting” is outputted to the display portion 6, as shown in the same row. In addition thereto, a comment “Please check back pressure, rotational velocity and position for each plasticization stage” is displayed on the display portion 6. To correct the molding condition in accordance with the determination message and the comment, the operator can take measures such as deleting the portion of the invalid stage number, changing the rotational velocity setting value at the portion of the invalid stage number, etc. The operator may neglect the determination message according to his/her own judgment.

### <Measured Value Diagnosis of Plasticization Step Time>

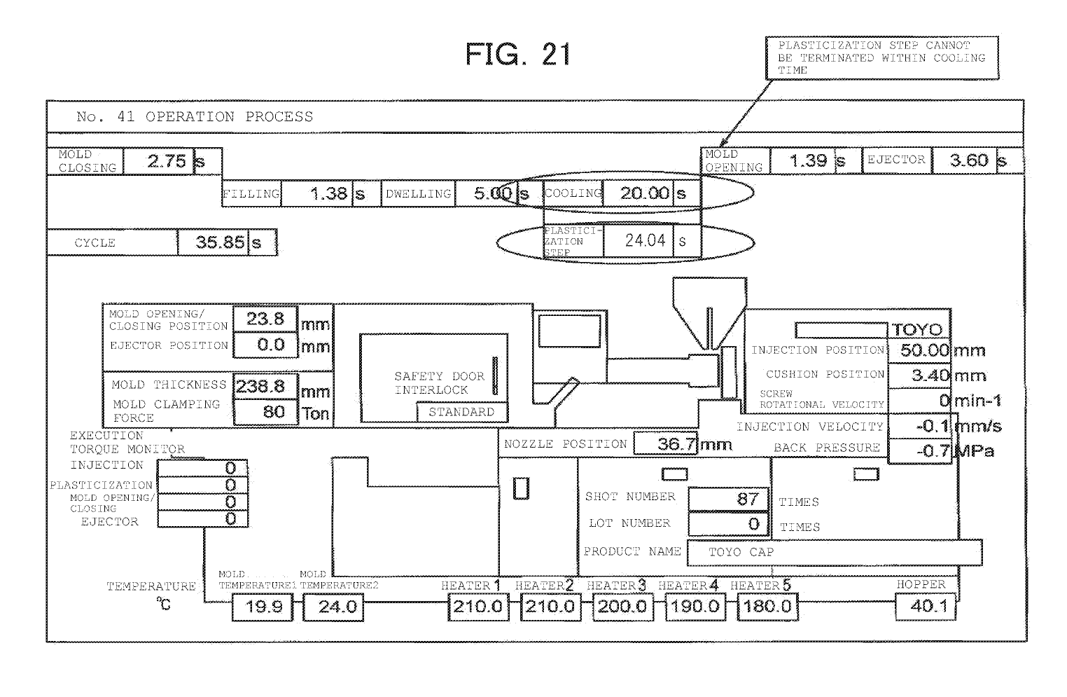

The plasticization step time is a total time of a metering delay time, a metering time and a suck-back time. It is supposed that a metering step is terminated within a cooling setting time in a general molding step. However, the metering time fluctuates due to various factors such as the kind of a raw resin. Therefore, there arises a case where a measured value of the plasticization step time exceeds the cooling setting time, as shown in FIG. 21. When the measured value of the plasticization step time exceeds the cooling setting time in this manner, this causes a variation in a cycle time. It is therefore desirable that the operator is informed of a message when the measured value of the plasticization step time exceeds the cooling setting time. To this end, in the embodiment, as shown in a second row of FIG. 20, “Plasticization Step Time > Cooling Time” is stored in advance in the storage portion 4, as a criterion for determining that the molding condition setting value is inappropriate. When the measured value of the plasticization step time exceeds the cooling time, a determination message “Plasticization step time exceeds cooling time” is outputted to the display portion 6, as shown in the same row. In addition thereto, a comment “Please check plasticization setting and cooling timer setting” is displayed on the display portion 6. To correct the molding condition in accordance with the determination message and the comment, the operator can take measures such as changing the metering condition to shorten the metering time, etc. The operator may neglect the determination message according to his/her own judgment.

### <Measured Value Diagnosis of Metering Start Position>

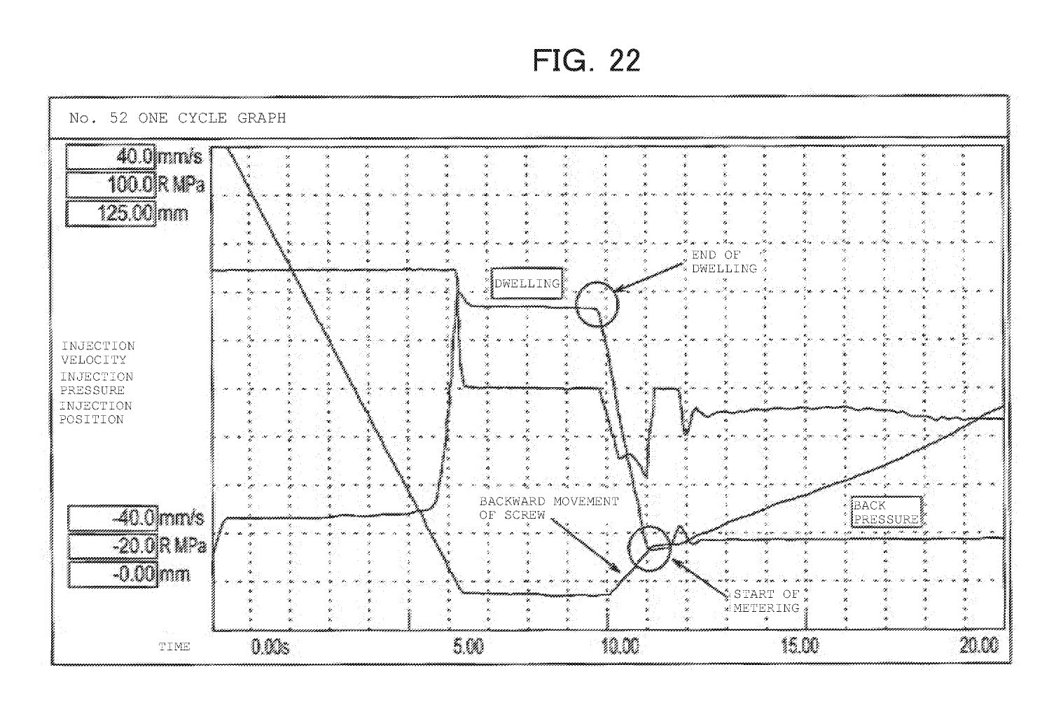

As shown in FIG. 22, the screw moves backward in order to perform decompression from the dwelling to the back pressure in pressure control for shifting from the dwelling step to the metering step. On this occasion, there is a case where metering is completed during the decompression step as to molding with a short metering stroke. Thus, there occurs a phenomenon that normal metering cannot be performed. It is therefore desirable that the operator is urged to pay attention when such a phenomenon occurs. To this end, in the embodiment, as shown in a third row of FIG. 20, “Decompression Amount at the Start of Metering > Reference Value” is stored in advance in the storage portion 4, as a criterion for determining that the molding condition setting value is inappropriate. When the decompression amount at the start of metering is larger than the reference value, a determination message “Metering start position becomes larger” is outputted to the display portion 6, as shown in the same row. In addition thereto, a comment “There is a possibility that pressure prior to metering is too high” is displayed on the display portion 6. To correct the molding condition in accordance with the determination message and the comment, the operator reconsiders the setting values of the respective portions so as to reduce the decompression amount at the start of metering.

### <Setting Value Diagnosis of Metering Time>

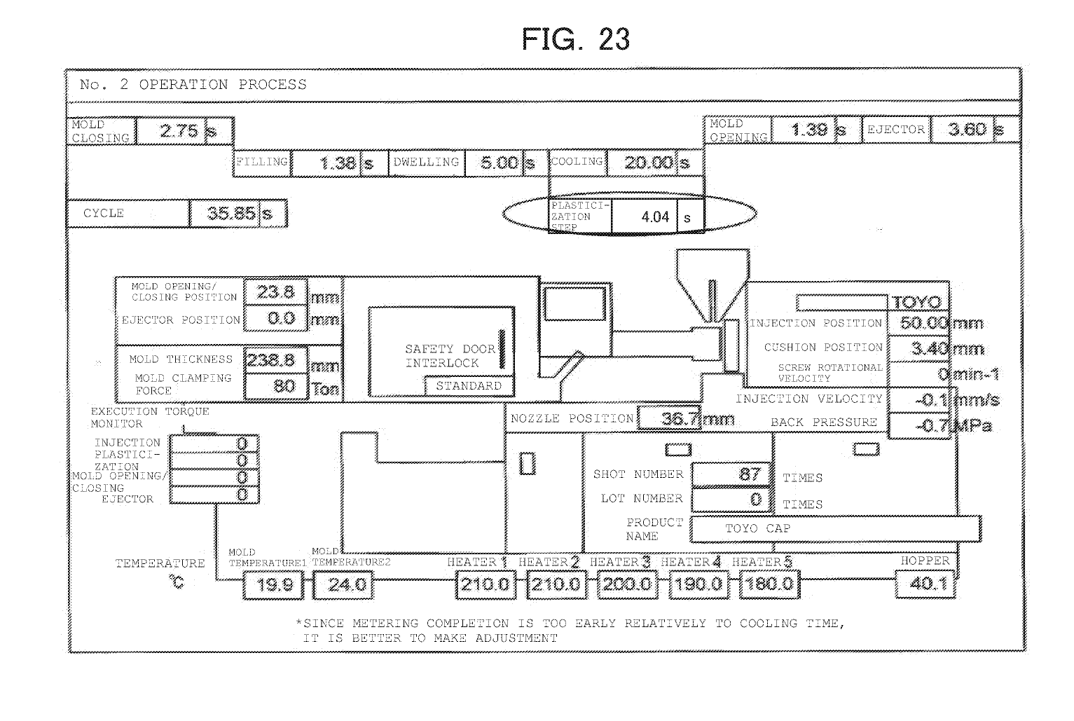

A suck-back step for reducing resin pressure after completion of the metering operation so as to prevent the molten resin from drooling from the tip of a nozzle during mold opening is provided in the metering step. The suck-back is an operation for moving the screw backward without rotation. When the metering time is too early relatively to the cooling time, a satisfactory drooling effect cannot be obtained. In an example of FIG. 23, the cooling time is 20.00 sec whereas the plasticization step time (metering time) is 4.04 sec. Thus, there is a possibility that a predetermined suck-back effect cannot be obtained. It is therefore desirable that the operator is urged to pay attention in such a case. To this end, in the embodiment, as shown in a fourth row of FIG. 20, “Metering Time > Reference Value” is stored in advance in the storage portion 4, as a criterion for determining that the molding condition setting value is inappropriate. When the metering time (time from completion of the suck-back step to the mold opening) is larger than the reference value, a determination message “Metering time becomes earlier” is outputted to the display portion 6, as shown in the same row. In addition thereto, a comment “Please check metering waiting and plasticization setting” is displayed on the display portion 6. To correct the molding condition in accordance with the determination message and the comment, the operator adjusts the metering waiting time or the number of rotations of the screw, etc.

### <Measured Value Diagnosis of Suck-Back>

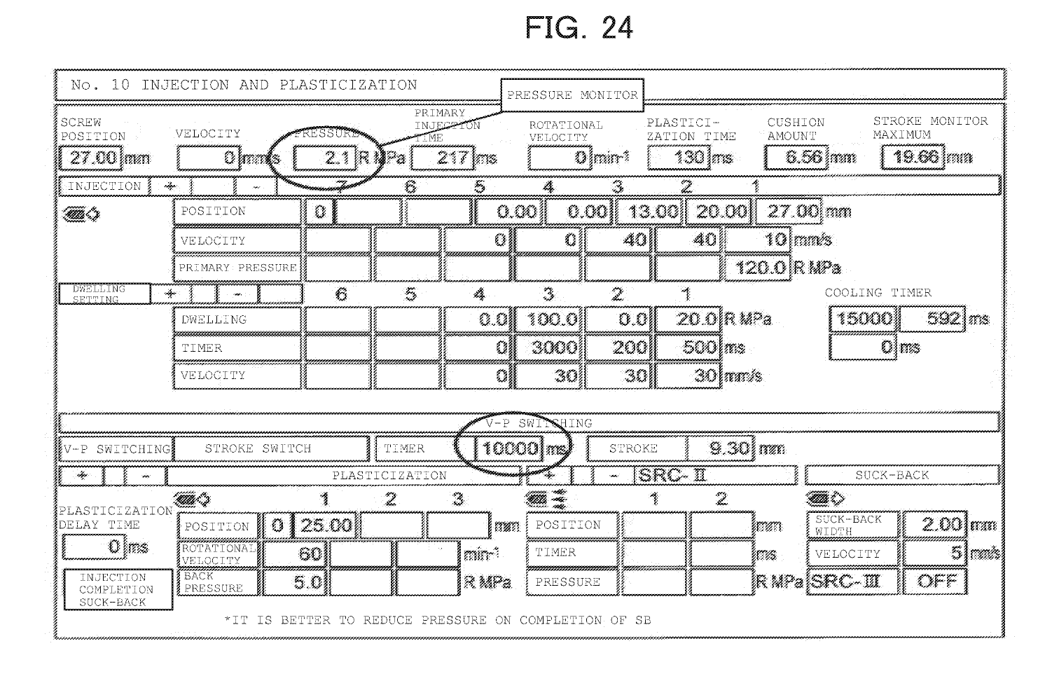

The suck-back is set for the purpose of preventing the metering resin which receives the back pressure, from drooling from the tip of the nozzle. Basically, the suck-back is set by setting a backward movement amount and backward movement velocity of the screw. However, since a load cell is provided in a rear end portion of the screw in the electric molding machine, the pressure of the metering resin (suck-back residual pressure) on completion of the suck-back can be set as a standard, as shown in FIG. 24. The suck-back residual pressure is not necessarily always 0 Pa but may be set based on empirical rules within a range in which the molding material does not drool from the tip of the nozzle. The suck-back residual pressure under which the molding material does not drool from the tip of the nozzle is determined based on the specifications of the molding machine body 10. When the suck-back residual pressure is excessively large, the possibility that the drooling occurs is high. It is therefore desirable that the operator is urged to pay attention. To this end, in the embodiment, as shown in a fifth row of FIG. 20, “Suck-Back Residual Pressure > Reference Value” is stored in advance in the storage portion 4, as a criterion for determining that the molding condition setting value is inappropriate. When the measured suck-back residual pressure is larger than the reference value, a determination message “Suck-back residual pressure is slightly large” is outputted to the display portion 6, as shown in the same row. In addition thereto, a comment “There is a possibility that suck-back amount is small” is displayed on the display portion 6. To correct the molding condition in accordance with the determination message and the comment, the operator adjusts the backward movement amount and the backward movement velocity of the screw.

### <Control Diagnosis of Metering Execution Torque>

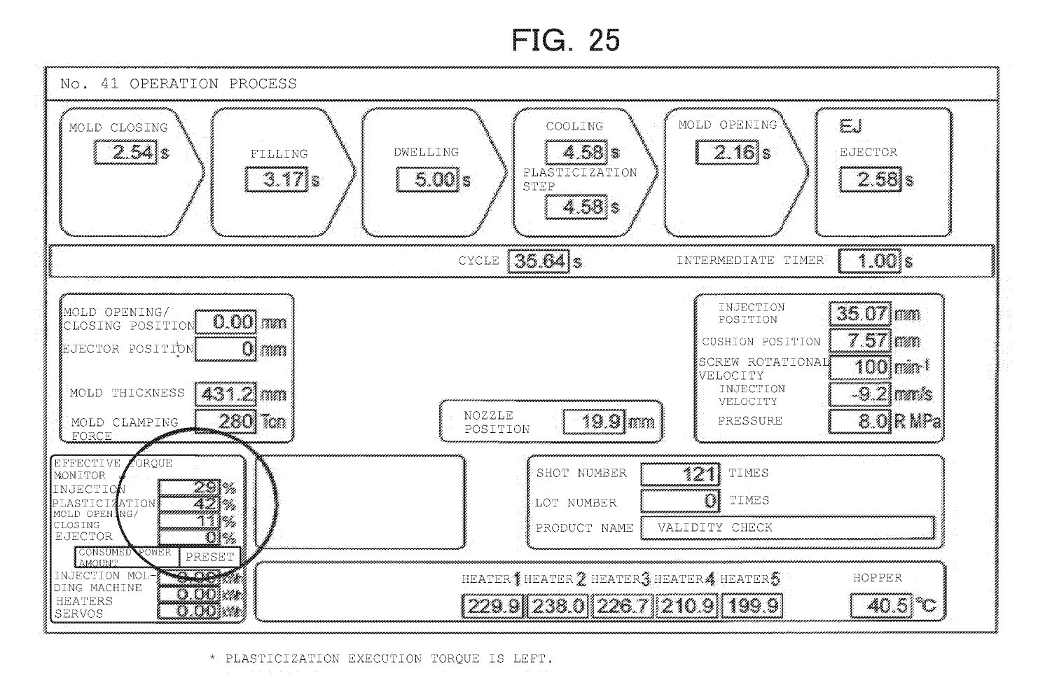

The metering execution torque is torque which is accumulated in the metering motor when a load of the metering motor is carried over to a next cycle. When the molding condition is appropriate, the driving time of the metering motor in one cycle is short enough to secure a margin in recovery time of the metering motor so that the metering execution torque cannot be accumulated in the metering motor. However, when torque during metering is high and the recovery time is short, the metering execution torque accumulated every cycle finally generates an overload. In an example of FIG. 25, metering execution torque of 42% is accumulated. The metering execution torque is also a reference value determined based on the specifications of the molding machine body 10. When the metering execution torque is accumulated in the metering motor as in the example of FIG. 25, there is a fear that the molding machine can be brought into a stop state. It is therefore desirable that the operator is urged to pay attention. To this end, in the embodiment, as shown in a sixth row of FIG. 20, “Metering Execution Torque > Reference Value” is stored in advance in the storage portion 4, as a criterion for determining that the molding condition setting value is inappropriate. When the measured value of the metering execution torque exceeds the reference value, a determination message “Accumulated load occurs in metering motor” is outputted to the display portion 6, as shown in the same row. In addition thereto, a comment “Please check temperature and metering setting and cycle time” is displayed on the display portion 6. To correct the molding condition in accordance with the determination message and the comment, the operator can perform adjustment to prolong the cycle time etc.

### <Control Diagnosis of Metering Load Torque>

The metering load torque is a load of the metering motor in the metering step. When a predetermined time elapses after the metering load torque reaches the maximum, the molding machine body 10 stops due to a “metering motor overload error”. In addition, it may be also assumed that when the load torque of the metering motor reaches the maximum, the metering motor becomes unstable to be controlled, as shown in FIG. 16. It is therefore necessary to urge the operator to pay attention. To this end, in the embodiment, as shown in a seventh row of FIG. 20, “Metering Load Torque > Reference Value” is stored in advance in the storage portion 4, as a criterion for determining that the molding condition setting value is inappropriate. When the measured value of the metering load torque exceeds the reference value, a determination message “Load of metering motor becomes higher” is outputted to the display portion 6, as shown in the same row. In addition thereto, a comment “Maximum load occurs in metering motor” is displayed on the display portion 6. To correct the molding condition in accordance with the determination message and the comment, the operator can reset the molding condition in a direction to reduce the load of the metering motor.

### <Measured Value Diagnosis of Electric Conduction Rates>

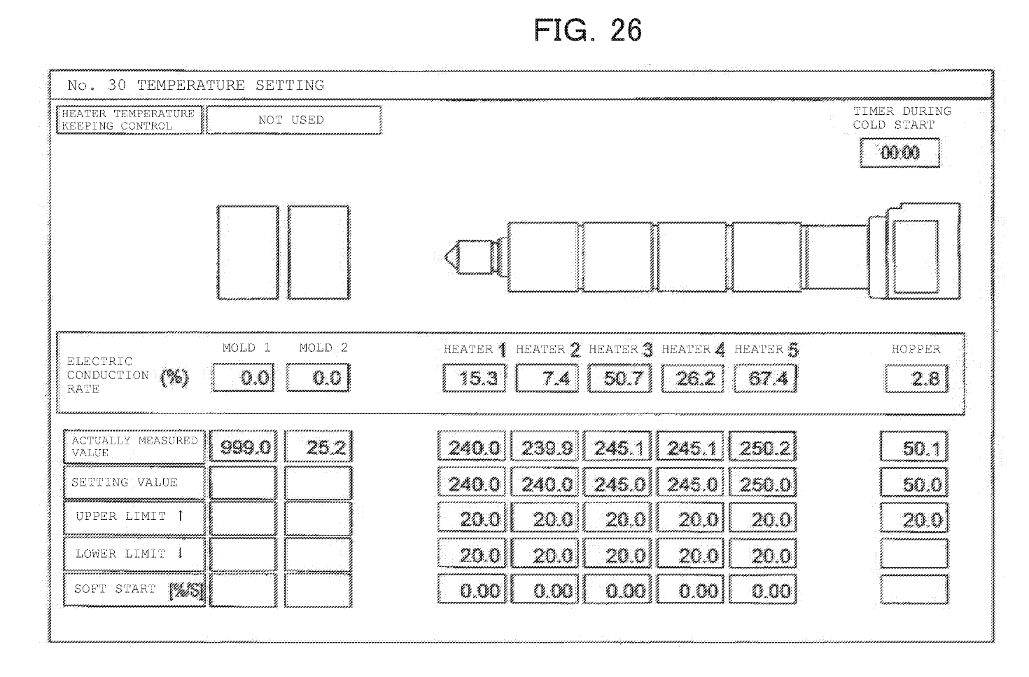

The electric conduction rates display electric conduction rates of heating cylinder heaters which perform ON/OFF control. As shown in FIG. 26 by way of example, numerical values corresponding to the respective heating cylinder heaters are displayed. Incidentally, in FIG. 26, “hopper 2.8” indicates a water flow rate about cooling under the hopper. When setting temperature of each heating cylinder heater is inappropriate, the molding material cannot be plasticized appropriately so that it is difficult to mold a good product stably. Accordingly, when the setting temperature of the heating cylinder heater is inappropriate, it is necessary to urge the operator to pay attention to adjust the setting appropriately. When the setting temperature of the heating cylinder heater is inappropriate, the electric conduction rate indicates an extreme value. Accordingly, when a reference value determined based on the specifications of the molding machine body 10 is measured as 0% or 100%, it can be determined that the electric conduction state is abnormal. Therefore, in the case of the example, as shown in an eighth row of FIG. 20, “Measured value of electric conduction rate is 0% or 100% (reference value)” is stored in advance in the storage portion 4, as a criterion for determining that the molding condition setting value is inappropriate. When the measured value of the electric conduction rate agrees with the reference value, a determination message “Electric conduction state is abnormal” is outputted to the display portion 6, as shown in the same row. In addition thereto, a comment “Please check temperature and metering setting” is displayed on the display portion 6. In order to correct the molding condition in accordance with the determination message, the operator can reconsider the temperature setting or change the metering condition.

### <Stability Diagnosis of Nozzle Temperature>

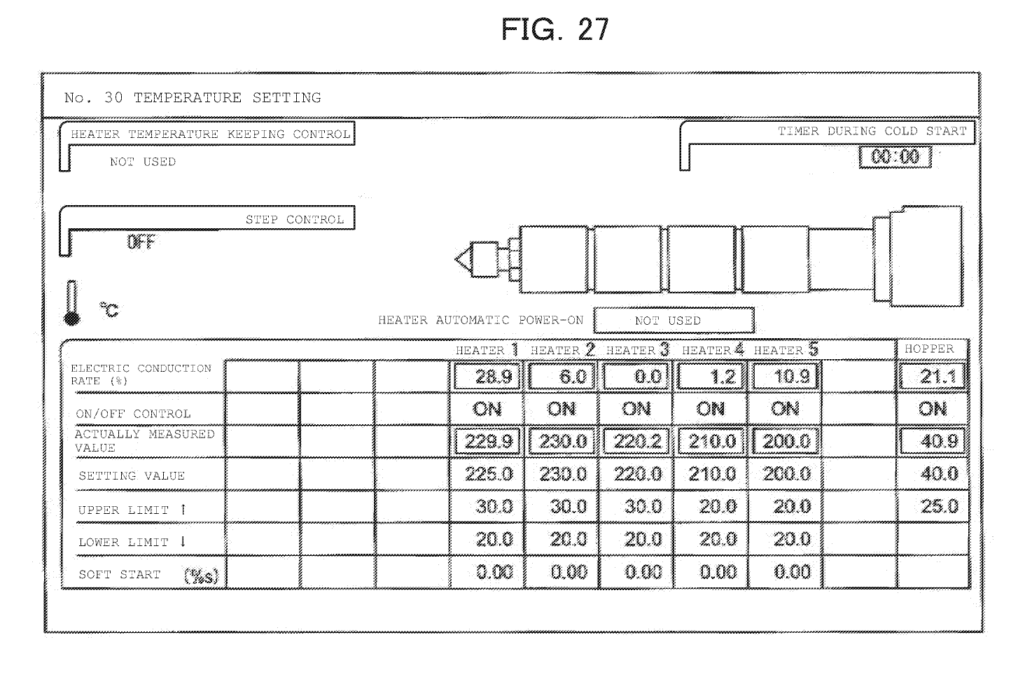

The injection nozzle provided in the injection device makes direct contact with the mold during continuous automatic operation. Accordingly, a variation in temperature is most easily generated in the injection nozzle. When the nozzle temperature fluctuates, viscosity of the molding material injected inside the cavity of the mold fluctuates. Therefore, there is a fear that the quality of a molded product is adversely affected. PID control is normally used for temperature control of the injection nozzle. In an initial state, initial tuning is performed on the PID control. The tuning of the PID control may deviate, for example, in the case where the kind of the injection nozzle is changed in accordance with the mold or the internal state of the injection nozzle changes due to maintenance of the screw. Therefore, in the embodiment, when change (maximum value−minimum value) in the measured value of the temperature is calculated every shot and the calculated temperature change exceeds a specified value, the operator is urged to pay attention. In an example of FIG. 27, the setting value of the temperature of “Heater 1” is 225.0° C. while the actually measured maximum value of the temperature of “Heater 1” is 229.9° C. It can be known that large temperature change is involved. Therefore, in the case of the example, as shown in a ninth row of FIG. 20, “Variation of Nozzle Temperature > Reference Value” is stored in advance in the storage portion 4, as a criterion for determining that the molding condition setting value is inappropriate. When the variation of the nozzle temperature is larger than the reference value, a determination message “There is a variation in nozzle temperature” is outputted to the display portion 6, as shown in the same row. In addition thereto, a comment “It is necessary to perform automatic tuning (nozzle)” is displayed on the display portion 6. In this manner, the operator can easily recognize that there is a variation larger than the reference value in the nozzle temperature. In addition, the operator can take proper measures rapidly to thereby stabilize operation of the molding machine body 10 as a whole. Accordingly, it is possible to manufacture a molded product with target quality in a target shot cycle. In order to correct the molding condition in accordance with the determination message, the operator can reconsider the temperature setting and take measures such as changing the metering condition or resetting the automatic tuning.

Next, molding condition diagnosis to be performed in the mold opening/closing step will be described in accordance with diagnosis items. In the embodiment, examples of the diagnosis items in the mold opening/closing step include control diagnosis of the number of mold closing stages, control diagnosis of the number of mold opening stages, setting value diagnosis of low-pressure mold clamping, measured value diagnosis of the low-pressure mold clamping, control diagnosis of the intermediate timer, control diagnosis of gate cutting, control diagnosis of mold opening/closing load torque, stability control of a mold opening time, stability diagnosis of a mold closing time, and stability diagnosis of an eject time.

### <Control Diagnosis of Number of Mold Closing Stages>

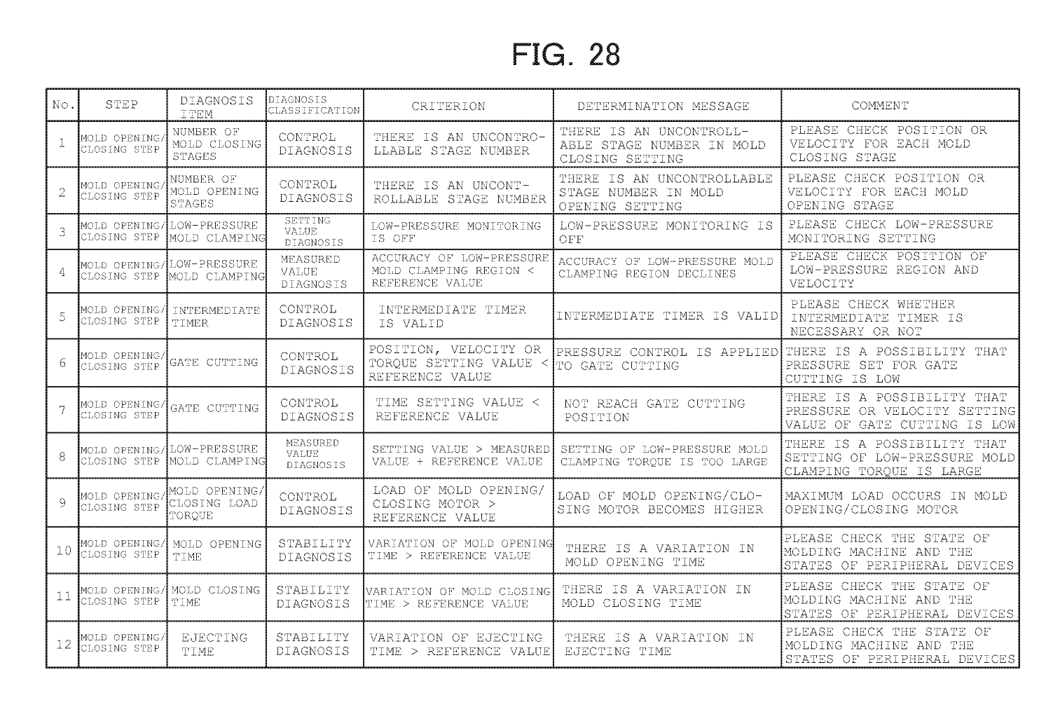

The number of control stages of mold closing position or velocity in the mold closing step can be set in the molding condition setting unit 30. Rotational velocity of the mold opening/closing motor can be controlled in accordance with setting values of respective stages. However, when the number of control stages set in the molding condition setting unit 30 is inappropriate, there arises a case where the rotational velocity of the mold opening/closing motor cannot be controlled in accordance with the setting values of the stages (see FIG. 9). There is also a fear that a control stage number at which the rotational velocity of the mold opening/closing motor cannot be controlled is useless and incorrect control is executed unexpectedly. It is therefore desirable that the operator is urged to pay attention when there is such a control stage number. To this end, in the embodiment, as shown in a first row of FIG. 28, “There is an uncontrollable stage number” is stored in advance in the storage portion 4, as a criterion for determining that the molding condition setting value is inappropriate. When there is a control stage at which the rotational velocity of the mold opening/closing motor is not controlled, a determination message “There is an uncontrollable stage number in mold closing setting” is outputted to the display portion 6, as shown in the same row. In addition thereto, a comment “Please check position or velocity setting for each mold closing stage” is displayed on the display portion 6. To correct the molding condition in accordance with the determination message and the comment, the operator can take measures such as deleting the portion of the invalid stage number, changing the mold closing position setting value or the velocity setting value at the portion of the invalid stage number, etc. The operator may neglect the determination message according to his/her own judgment.

### <Control Diagnosis of Number of Mold Opening Stages>

The number of control stages of mold opening position or velocity in the mold opening step can be set in the molding condition setting unit 30. The rotational velocity of the mold opening/closing motor can be controlled in accordance with setting values of respective stages. However, when the number of control stages set in the molding condition setting unit 30 is inappropriate, there arises a case where the rotational velocity of the mold opening/closing motor cannot be controlled in accordance with the setting values of the stages (see FIG. 9). It is desirable that the operator is urged to pay attention also in this case. To this end, in the embodiment, as shown in a second row of FIG. 28, “There is an uncontrollable stage number” is stored in advance in the storage portion 4, as a criterion for determining that the molding condition setting value is inappropriate. When there is a control stage at which the rotational velocity of the mold opening/closing motor is not controlled, a determination message “There is an uncontrollable stage number in mold opening setting” is outputted to the display portion 6, as shown in the same row. In addition thereto, a comment “Please check position or velocity setting for each mold opening stage” is displayed on the display portion 6. To correct the molding condition in accordance with the determination message and the comment, the operator can take measures such as deleting the portion of the invalid stage number, changing the mold opening position setting value or the velocity setting value at the portion of the invalid stage number, etc. The operator may neglect the determination message according to his/her own judgment.

### <Setting Value Diagnosis of Low-Pressure Mold Clamping>

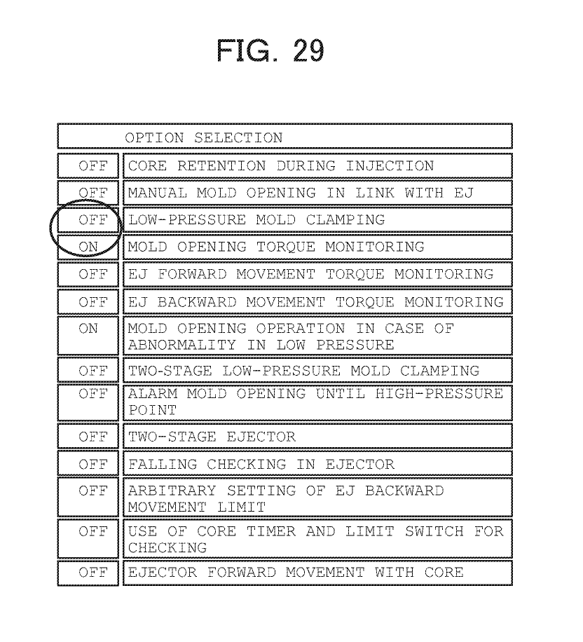

The low-pressure mold clamping is set in order to automatically stop a mold closing operation and prevent damage of the mold upon detection of abnormal increase in mold opening/closing motor load torque which is generated when a product or foreign matters are interposed between parts of the mold in the mold closing step. Various functions for securing safety or various functions for preventing damage are provided in the molding machine. The operator can operate the molding condition setting unit 30 to set ON/OFF of the low-pressure mold clamping, as shown in FIG. 29. However, the low-pressure mold clamping is often reset after the molding status is stabilized. The low-pressure mold clamping set inappropriately in the initial stage may be left as it is. Accordingly, when the low-pressure mold clamping torque of monitoring setting is inappropriate during continuous automatic operation, it is desirable that the operator is urged to pay attention so that the operator can be prevented from forgetting the resetting. To this end, in the case of the example, as shown in a third row of FIG. 28, “Low-pressure mold clamping monitoring device is OFF” is stored in advance in the storage portion 4, as a criterion for determining that the molding condition setting value is inappropriate. When the low-pressure mold clamping monitoring device is OFF, a determination message “Low-pressure mold clamping monitoring device is OFF” is outputted to the display portion 6, as shown in the same row. In addition thereto, a comment “Please check low-pressure monitoring setting” is displayed on the display portion 6. To correct the molding condition in accordance with the determination message, the operator can turn ON the low-pressure mold clamping monitoring device.

### <Measured Value Diagnosis of Low-Pressure Mold Clamping>

In order to monitor the abnormal increase in the mold opening/closing motor load torque in the low-pressure mold clamping step, it is necessary to appropriately set a low-pressure operation region for performing monitoring operation. The low-pressure operation region can be set by setting positions of a start point and an end point of the low-pressure operation region and operation velocity and monitoring torque of the mold opening/closing mechanism in the molding condition diagnostic unit 30. In this case, there arises a case where the monitoring torque cannot be detected normally when setting values of the positions, the operation velocity and the monitoring torque set in the molding condition diagnostic unit 30 are inappropriate. It is therefore desirable that the operator is urged to pay attention. To this end, in the case of the example, as shown in a fourth row of FIG. 28, “Accuracy of Low-Pressure Mold Clamping Region < Reference Value” is stored in advance in the storage portion 4, as a criterion for determining that the molding condition setting value is inappropriate. When the monitoring torque cannot be monitored, a determination message “Accuracy of low-pressure mold clamping region declines” is outputted to the display portion 6, as shown in the same row. In addition thereto, a comment “Please check position of low-pressure operation region and velocity” is displayed on the display portion 6. To correct the molding condition in accordance with the determination message, the operator can reset the positions of the start point and the end point of the low-pressure operation region and the operation velocity and the monitoring torque of the mold opening/closing mechanism.

### <Control Diagnosis of Intermediate Timer>

The intermediate timer is set as an interval time between eject forward movement during continuous molding and the start of a next cycle. When a setting time of the intermediate timer is too short, there arises a problem that the next cycle cannot be started in spite of completion of the intermediate timer due to a variation of a product ejecting time. It is therefore desirable that the operator is urged to pay attention. To this end, in the case of the example, as shown in a fifth row of FIG. 28, “Intermediate timer is valid” is stored in advance in the storage portion 4, as a criterion for determining that the molding condition setting value is inappropriate. When the next cycle cannot be started in spite of completion of the intermediate timer, a determination message “Intermediate timer is valid” is outputted to the display portion 6, as shown in the same row. In addition thereto, a comment “Please check whether intermediate timer is necessary or not” is displayed on the display portion 6. To correct the molding condition in accordance with the determination message, the operator can take measures such as prolonging the setting time of the intermediate timer, etc.

### <Control Diagnosis of Gate Cutting (Position and Velocity Control)>

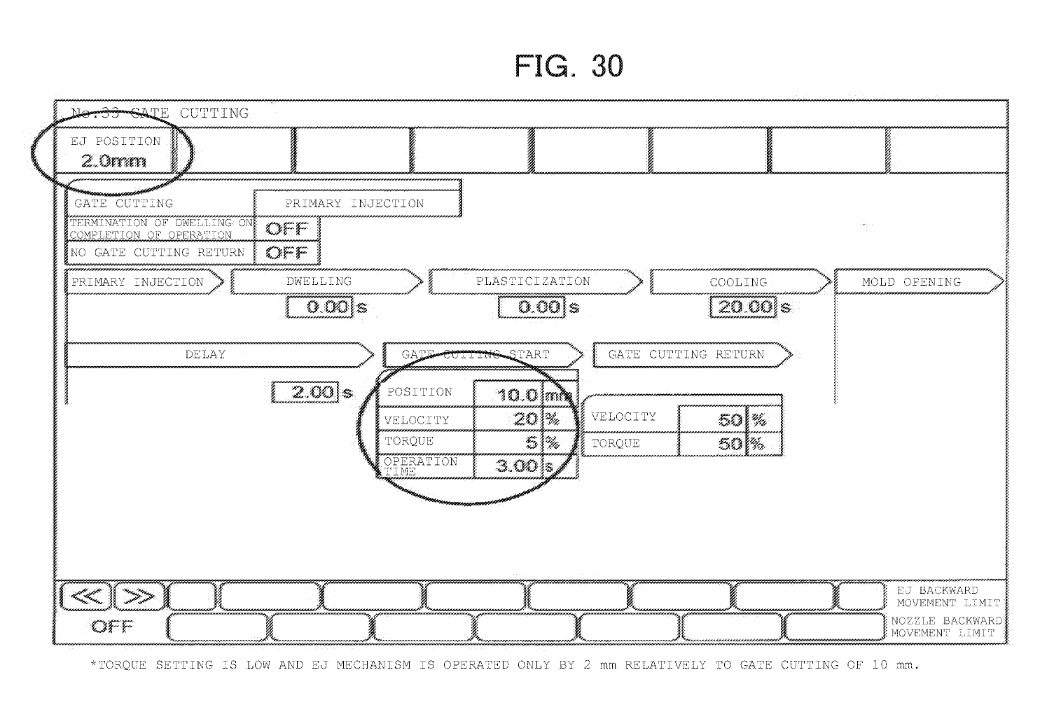

The gate cutting control is made for the purpose of using the eject mechanism during injection to cut or compress a gate of a molded product. As shown in FIG. 30, the gate cutting control is set by setting position, velocity, torque and an operation time of the eject mechanism. The gate cutting control is performed by position control or velocity control in principle. However, torque control and time control are also used for monitoring in the gate cutting control due to its characteristics. When setting values of the torque and the operation time are inappropriate, they may impede the position control or the velocity control. In an example of FIG. 30, the torque is set at 5%. Since the torque is too low, the eject mechanism can be actually operated by only 2 mm while 10 mm is set as the gate cutting position. Therefore, the eject mechanism is bought into an uncontrollable state. In order to control the eject mechanism normally, it is expedient that the operator can be urged to pay attention in such a case. To this end, in the case of the example, as shown in a sixth row of FIG. 28, “Position, Velocity or Torque Setting Value < Reference Value” is stored in advance in the storage portion 4, as a criterion for determining that the molding condition setting value is inappropriate. When the eject mechanism is not controlled by position control or velocity control, a determination message “Pressure control is applied to gate cutting operation” is outputted to the display portion 6, as shown in the same row. In addition thereto, a comment “There is a possibility that pressure set for gate cutting is low” is displayed on the display portion 6. To correct the molding condition in accordance with the determination message, the operator can take measures such as changing the setting of the gate cutting position, the gate cutting velocity or the gate cutting time.

### <Control Diagnosis of Gate Cutting (Time Control)>

As described above, the gate cutting is set by setting the position, the velocity, the torque and the operation time of the eject mechanism (see FIG. 30). In this case, when the gate cutting is controlled according to time priority, the gate cutting mechanism shifts to a next step as soon as it comes to the setting time regardless of whether the gate cutting mechanism reaches a predetermined position or not. Accordingly, when the gate cutting mechanism does not reach the predetermined position in the case where the gate cutting is controlled according to time priority, it is necessary to urge the operator to pay attention. To this end, in the case of the example, as shown in a seventh row of FIG. 28, “Setting Value of Gate Cutting Time < Reference Value” is stored in advance in the storage portion 4, as a criterion for determining that the molding condition setting value is inappropriate. When the eject mechanism cannot reach the predetermined position, a determination message “Not reach gate cutting position yet” is outputted to the display portion 6, as shown in the same row. In addition thereto, a comment “There is a possibility that pressure or velocity setting value of gate cutting is low” is displayed on the display portion 6. To correct the molding condition in accordance with the determination message, the operator can take measures such as changing the setting of the gate cutting position, the gate cutting velocity or the gate cutting time, etc.

### <Measured Value Diagnosis of Low-Pressure Mold Clamping>

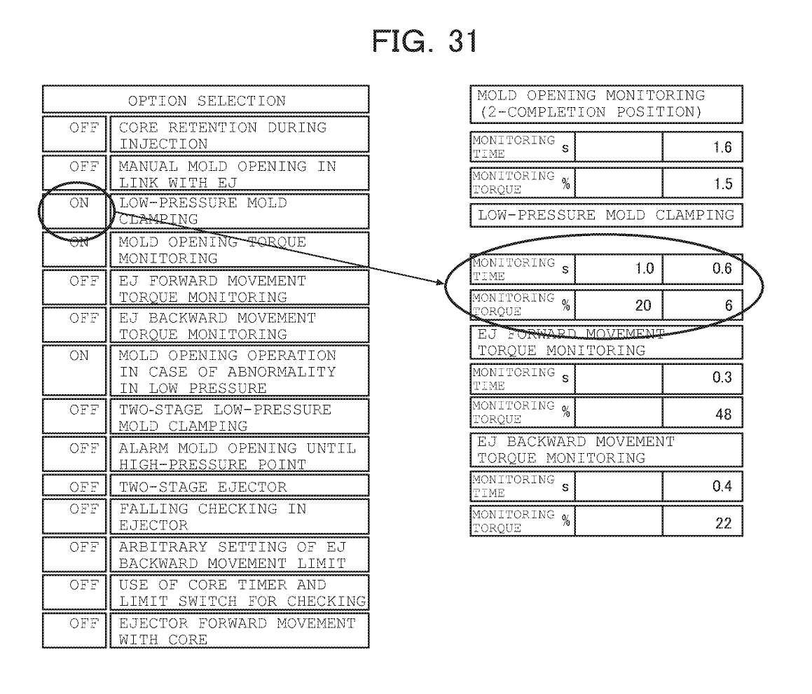

As shown in FIG. 31, the low-pressure mold clamping mechanism is set by setting a monitoring time and monitoring torque in the molding condition diagnostic unit 30. In the example of FIG. 31, while actual monitoring torque is 6%, a setting value of the monitoring torque is 20%. When the setting value of the monitoring torque is too large in comparison with the actual monitoring torque in this manner, detection of torque rise delays to thereby increase damage on the mold. Accordingly, when the setting value of the monitoring torque is inappropriate during continuous automatic operation, it is necessary to urge the operator to pay attention to make the setting value of the monitoring torque appropriate. To this end, in the case of the example, as shown in an eighth row of FIG. 28, “Setting Value > Measured Value+Reference Value” is stored in advance in the storage portion 4, as a criterion for determining that the molding condition setting value is inappropriate. When the setting value of the low-pressure mold clamping torque is excessively large, a determination message “Setting of low-pressure mold clamping torque is too large” is outputted to the display portion 6, as shown in the same row. In addition thereto, a comment “There is a possibility that setting of low-pressure mold clamping is large” is displayed on the display portion 6. To correct the molding condition in accordance with the determination message, the operator can reset a value higher by about 5% to 10% than the measured value, as the setting value of the low-pressure mold clamping torque.

### <Control Diagnosis of Mold Opening/Closing Load Torque>

The mold opening/closing load torque is a load of the mold opening/closing motor in the mold opening/closing step. When a predetermined time elapses after the mold opening/closing load torque reaches the maximum, the molding machine body 10 stops due to a “mold opening/closing motor overload error”. In addition, it may be also assumed that when the load torque of the mold opening/closing motor reaches the maximum, the mold opening/closing motor becomes unstable to be controlled, as shown in FIG. 16. It is therefore necessary to urge the operator to pay attention. To this end, in the embodiment, as shown in a ninth row of FIG. 28, “Measured Value > Reference Value” is stored in advance in the storage portion 4, as a criterion for determining that the molding condition setting value is inappropriate. When the measured value exceeds the reference value, a determination message “Load of mold opening/closing motor becomes higher” is outputted to the display portion 6, as shown in the same row. In addition thereto, a comment “Maximum load occurs in mold opening/closing motor” is displayed on the display portion 6. To correct the molding condition in accordance with the determination message and the comment, the operator can reset the molding condition in a direction to reduce the load of the mold opening/closing motor.

### <Stability Diagnosis of Mold Opening Time>

Regardless of appropriateness of the molding condition set in the molding condition setting unit 30, there also appears a variation in the mold opening time similarly to the primary injection time in the case where there is abnormality in the various servomotors provided in the molding machine body 10 or in the case where a temporal variation occurs in a step in which the peripheral devices are operated. Accordingly, the variation of the mold opening time can be calculated, so that occurrence of abnormality in the various servomotors or the peripheral devices can be estimated. Accordingly, when the variation of the mold opening time is large, it is desirable that the operator is urged to pay attention in order to enable timely maintenance. To this end, in the embodiment, mold opening time data for a predetermined number of shots (for example, 50 shots or 100 shots) are imported continuously into the storage portion 4 and a deviation between a maximum value and a minimum value of the imported mold opening time data is obtained by the arithmetic processing portion 3. When the obtained deviation is larger than a deviation reference value of the mold opening time, for example, larger than 0.1 sec, a determination message “There is a variation in mold opening time” is displayed on the display portion 6, as shown in a tenth row of FIG. 28. In addition thereto, a comment “Please check the state of molding machine and the states of peripheral devices” is displayed on the display portion 6. In addition thereto, a comment “Please check the state of molding machine and the states of peripheral devices” is displayed on the display portion 6. In this manner, the operator can easily recognize that there is a variation larger than the reference value in the mold opening time. In addition, the operator can take suitable measures rapidly. Accordingly, operation of the molding machine body 10 as a whole can be stabilized so that a molded product with target quality can be manufactured in a target shot cycle. Incidentally, the measurement data of the mold opening time are displayed on the display portion 6 to be numerical values for the respective shots in a list, as shown in FIG. 17. FIG. 17 shows the measurement data of the mold opening time in a normal occasion. As obvious from FIG. 17, the mold opening time is very stable in the normal occasion.

### <Stability Control of Mold Closing Time>

Regardless of appropriateness of the molding condition set in the molding condition setting unit 30, there also appears a variation in the mold closing time similarly to the primary injection time in the case where there is abnormality in the various servomotors provided in the molding machine body 10 or in the case where a temporal variation occurs in a step in which the peripheral devices are operated. Accordingly, the variation of the mold closing time can be calculated, so that occurrence of abnormality in the various servomotors or the peripheral devices can be estimated. Also in this case, it is desirable that the operator is urged to pay attention in order to enable timely maintenance. To this end, in the embodiment, mold closing time data for a predetermined number of shots (for example, 50 shots or 100 shots) are imported continuously into the storage portion 4 and a deviation between a maximum value and a minimum value of the imported mold closing time data is obtained by the arithmetic processing portion 3. When the obtained deviation is larger than a deviation reference value of the mold closing time, for example, larger than 0.1 sec, a determination message “There is a variation in mold closing time” is displayed on the display portion 6, as shown in an eleventh row of FIG. 28. In addition thereto, a comment “Please check the state of molding machine and the states of peripheral devices” is displayed on the display portion 6. In this manner, the operator can easily recognize that there is a variation larger than the reference value in the mold closing time. In addition, the operator can take suitable measures rapidly. Accordingly, operation of the molding machine body 10 as a whole can be stabilized so that a molded product with target quality can be manufactured in a target shot cycle.

### <Stability Control of Molded Product Ejecting Time>

Regardless of appropriateness of the molding condition set in the molding condition setting unit 30, there also appears a variation in the molded product ejecting time similarly to the primary injection time in the case where there is abnormality in the various servomotors provided in the molding machine body 10 or in the case where a temporal variation occurs in a step in which the peripheral devices are operated. Accordingly, the variation of the molded product ejecting time can be calculated, so that occurrence of abnormality in the various servomotors or the peripheral devices can be estimated. Also in this case, it is desirable that the operator is urged to pay attention in order to enable timely maintenance. To this end, in the embodiment, molded product ejecting time data for a predetermined number of shots (for example, 50 shots or 100 shots) are imported continuously into the storage portion 4 and a deviation between a maximum value and a minimum value of the imported molded product ejecting time data is obtained by the arithmetic processing portion 3. When the obtained deviation is larger than a deviation reference value of the molded product ejecting time, for example, larger than 0.1 sec, a determination message “There is a variation in ejecting time” is displayed on the display portion 6, as shown in a twelfth row of FIG. 28. In addition thereto, a comment “Please check the state of molding machine and the states of peripheral devices” is displayed on the display portion 6. In this manner, the operator can easily recognize that there is a variation larger than the reference value in the mold closing time. In addition, the operator can take suitable measures rapidly. Accordingly, operation of the molding machine body 10 as a whole can be stabilized so that a molded product with target quality can be manufactured in a target shot cycle.

Next, molding condition diagnosis to be performed in the other steps will be described in accordance with diagnosis items. In the embodiment, examples of the diagnosis items in the other steps include setting value diagnosis of the number of EJ stages, control diagnosis of EJ load torque, control diagnosis of air blowing, setting value diagnosis of mold clamping force, control diagnosis of the mold clamping force, setting value diagnosis of monitor items, setting value diagnosis of monitor determination, setting value diagnosis of continuous defective product setting, setting value diagnosis of condition storage, stability diagnosis of injection pressure, and stability diagnosis of a plasticization time.

### <Control Diagnosis of Number of EJ Stages>

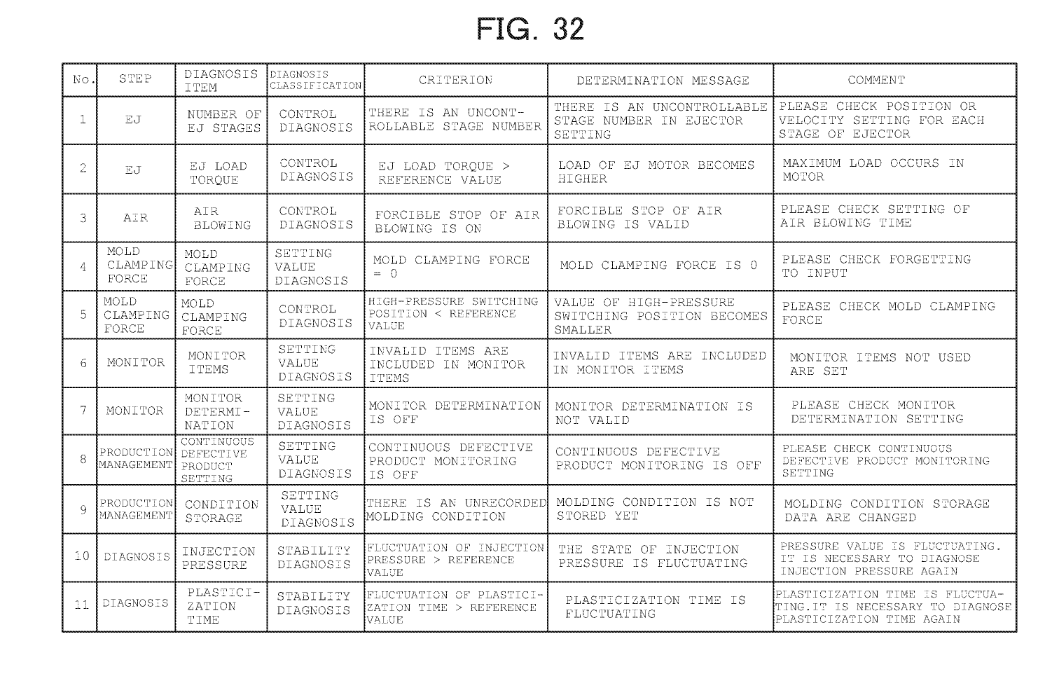

The number of control stages of EJ position or velocity in the molded product ejecting step can be set in the molding condition setting unit 30. Rotational velocity of the EJ motor can be controlled in accordance with setting values of respective stages. However, when the number of control stages set in the molding condition setting unit 30 is inappropriate, there arises a case where the rotational velocity of the EJ motor cannot be controlled in accordance with the setting values of the stages (see FIG. 9). There is also a fear that a control stage number at which the rotational velocity of the EJ motor cannot be controlled is useless and incorrect control is executed unexpectedly. It is therefore desirable that the operator is urged to pay attention when there is such a control stage number. To this end, in the embodiment, as shown in a first row of FIG. 32, “There is an uncontrollable stage number” is stored in advance in the storage portion 4, as a criterion for determining that the molding condition setting value is inappropriate. When there is a control stage at which the rotational velocity of the EJ motor is not controlled, a determination message “There is an uncontrollable stage number in EJ setting” is outputted to the display portion 6, as shown in the same row. In addition thereto, a comment “Please check position or velocity setting for each EJ stage” is displayed on the display portion 6. To correct the molding condition in accordance with the determination message and the comment, the operator can take measures such as deleting the portion of the invalid stage number, changing the EJ position setting value or the velocity setting value at the portion of the invalid stage number, etc. The operator may neglect the determination message according to his/her own judgment.

### <Control Diagnosis of EJ Load Torque>

The EJ load torque is a load of the EJ motor in the EJ step. When a predetermined time elapses after the EJ load torque reaches the maximum, the molding machine body 10 stops due to an “EJ motor overload error”. In addition, it may be also assumed that when the load torque of the EJ motor reaches the maximum, the EJ motor becomes unstable to be controlled, as shown in FIG. 16. It is therefore desirable that the operator is urged to pay attention. To this end, in the embodiment, as shown in a second row of FIG. 32, “EJ Load Torque > Reference Value” is stored in advance in the storage portion 4, as a criterion for determining that the molding condition setting value is inappropriate. When the measured value of the EJ load torque exceeds the reference value, a determination message “Load of EJ motor becomes higher” is outputted to the display portion 6, as shown in the same row. In addition thereto, a comment “Maximum load occurs in EJ motor” is displayed on the display portion 6. To correct the molding condition in accordance with the determination message and the comment, the operator can reset the molding condition in a direction to reduce the load of the EJ motor.

### <Control Diagnosis of Air Blowing>

An air blowing function is used as mold release assistance during mold opening. The air blowing function is set by setting a start position and an air blowing time. When the setting time of the air blowing is too long, the air blowing function affects the injection step. For this reason, the air blowing function is arranged to be able to be forcibly terminated in any step. Thus, when a forcible termination position is set, the air blowing function can be terminated forcibly. Therefore, the air blowing function has limited influence on the injection step, but the forcible termination operation is originally an emergent stop function. It is not preferable to use the forcible termination operation constantly. Accordingly, when the air blowing function is forcibly terminated, it is desirable that the operator is urged to pay attention. To this end, in the embodiment, as shown in a third row of FIG. 32, “Forcible stop of air blowing is ON” is stored in advance in the storage portion 4, as a criterion for determining that the molding condition setting value is inappropriate. When the air blowing function is terminated forcibly, a determination message “Forcible termination of air blowing is valid” is outputted to the display portion 6, as shown in the same row. In addition thereto, a comment “Please check setting of air blowing time” is displayed on the display portion 6. To correct the molding condition in accordance with the determination message and the comment, the operator can change the setting of the air blowing time.

### <Setting Value Diagnosis of Mold Clamping Force>

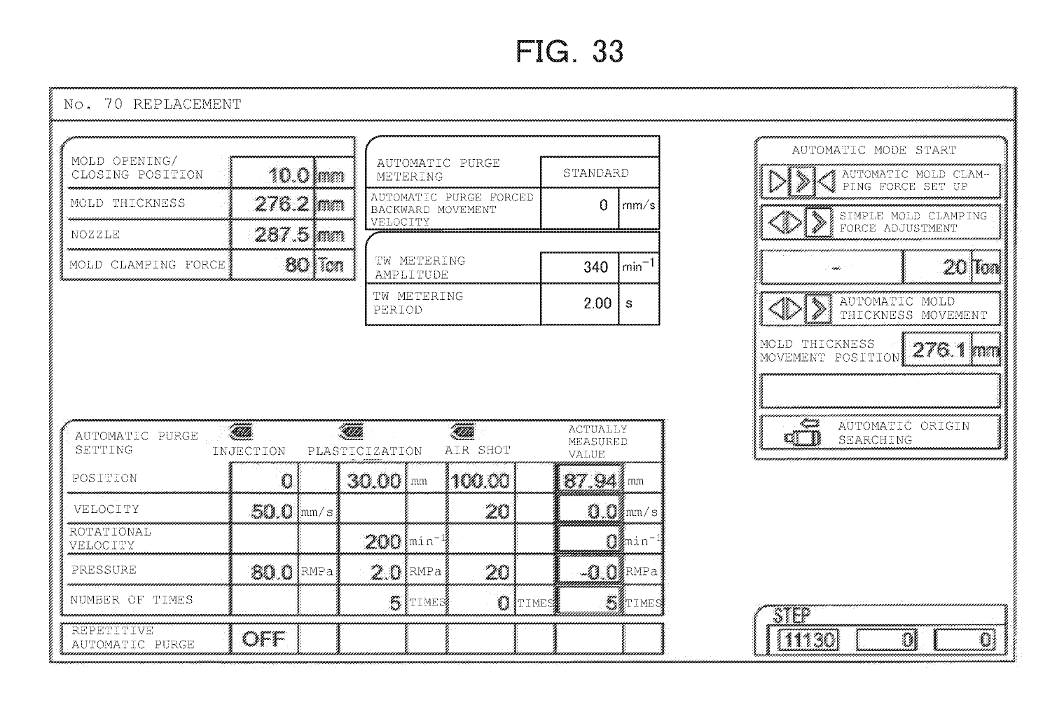

As shown in FIG. 33, mold clamping force is set in the molding condition setting unit 30 so that the mold clamping force can be generated by automatic mold clamping force adjustment in a toggle-type molding machine. In the example of FIG. 33, 80 tons is set as the mold clamping force. In this case, a toggle-type mold clamping device is additionally clamped by 80 tons so that a proper molded product can be manufactured continuously. On the other hand, when the setting of the mold clamping force in the molding condition setting unit 30 is forgotten and the mold clamping force is set at 0, control of the mold clamping force is impossible so that a serious problem such as damage of the mold may be caused. It is therefore desirable that the operator is urged to pay attention when the setting value of the mold clamping force is 0. To this end, in the embodiment, as shown in a fourth row of FIG. 32, “Setting Value of Mold Clamping Force=0” is stored in advance in the storage portion 4, as a criterion for determining that the molding condition setting value is inappropriate. When the setting value of the mold clamping force is 0, a determination message “Setting value of mold clamping force is 0” is outputted to the display portion 6, as shown in the same row. In addition thereto, a comment “Please check forgetting to input” is displayed on the display portion 6. In accordance with the determination message and the comment, the operator can set proper mold clamping force in the molding condition setting unit 30.

### <Control Diagnosis of Mold Clamping Force>

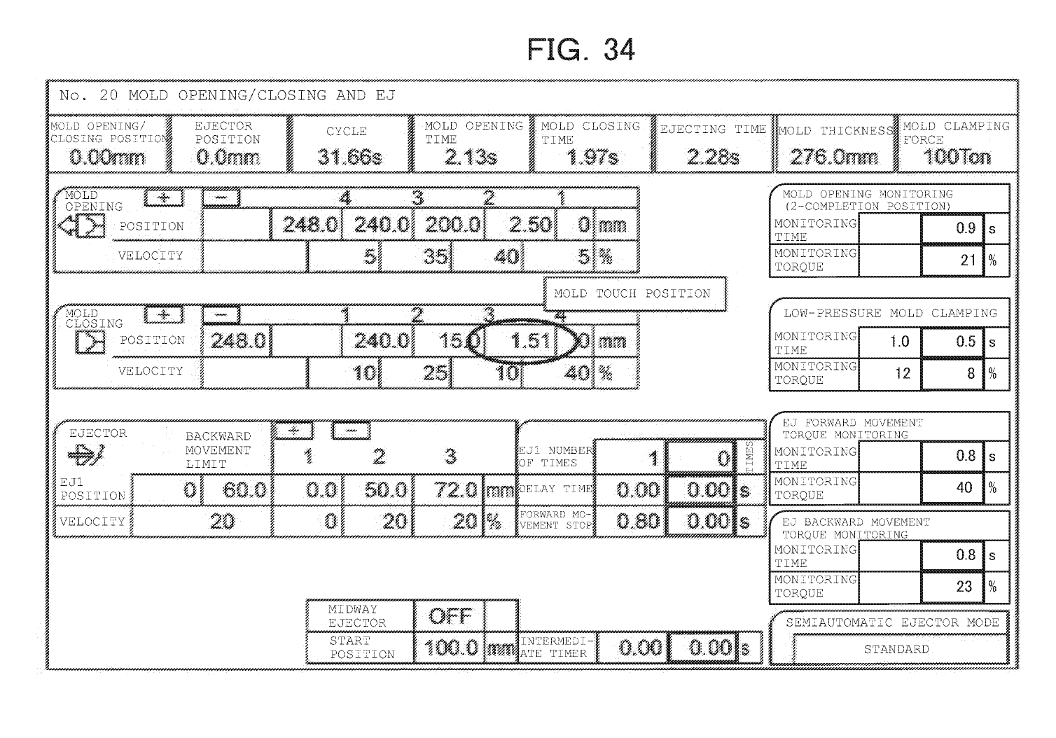

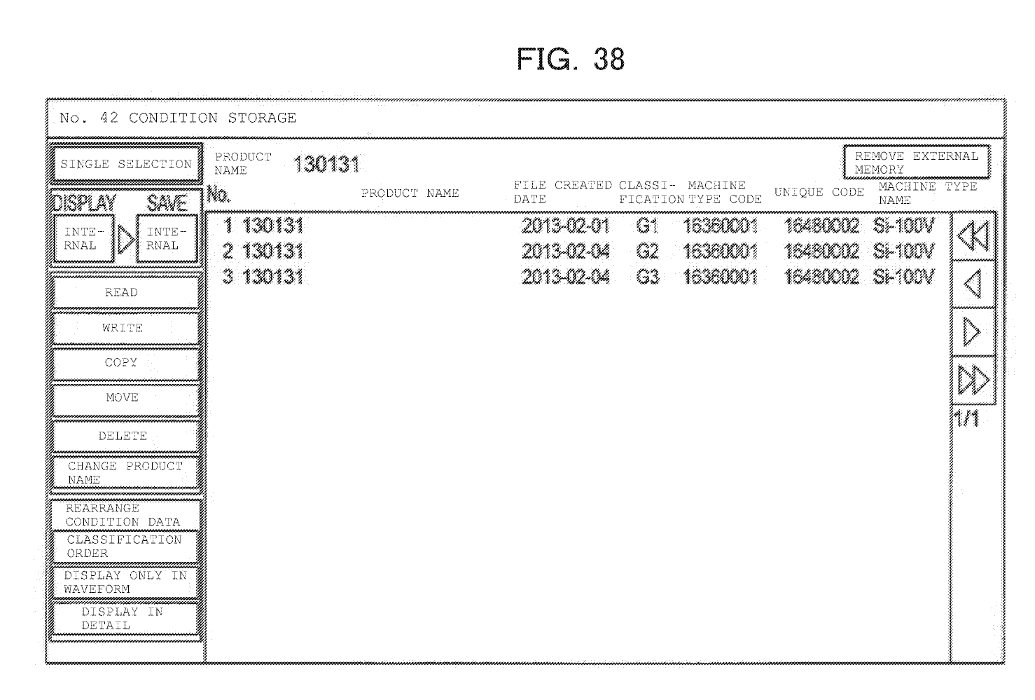

When the mold clamping mechanism is automatically adjusted to generate the mold clamping force set in the molding condition unit 30 in the toggle-type molding machine, a mold touch position is simultaneously detected and displayed on the display portion 6 as shown in FIG. 38. In the example of FIG. 34, the mold touch position is 1.51 mm which is a proper value. However, when the setting value of the mold clamping force is too small, the value of the mold touch position is also small correspondingly. When the mold touch position is monitored and the value of the mold touch position is too small, there is a possibility that the setting value of the mold clamping force is too small. It is therefore desirable that the operator is urged to pay attention. Incidentally, several kinds such as “Ton” and “kN” can be used as setting units of the mold clamping force. For this reason, it is easy to input a wrong setting value of the mold clamping force by mistake. Therefore, in the embodiment, as shown in a fifth row of FIG. 32, “High-Pressure Switching Position < Reference Value” is stored in advance in the storage portion 4, as a criterion for determining that the molding condition setting value is inappropriate. When the mold touch position (high-pressure switching position) is smaller than the reference value, a determination message “Value of high-pressure switching position becomes smaller” is outputted to the display portion 6, as shown in the same row. In addition thereto, a comment “Please check mold clamping force” is displayed on the display portion 6. In accordance with the determination message and the comment, the operator checks the mold clamping force set in the molding condition setting unit 30.

### <Setting Value Diagnosis of Monitor Items>

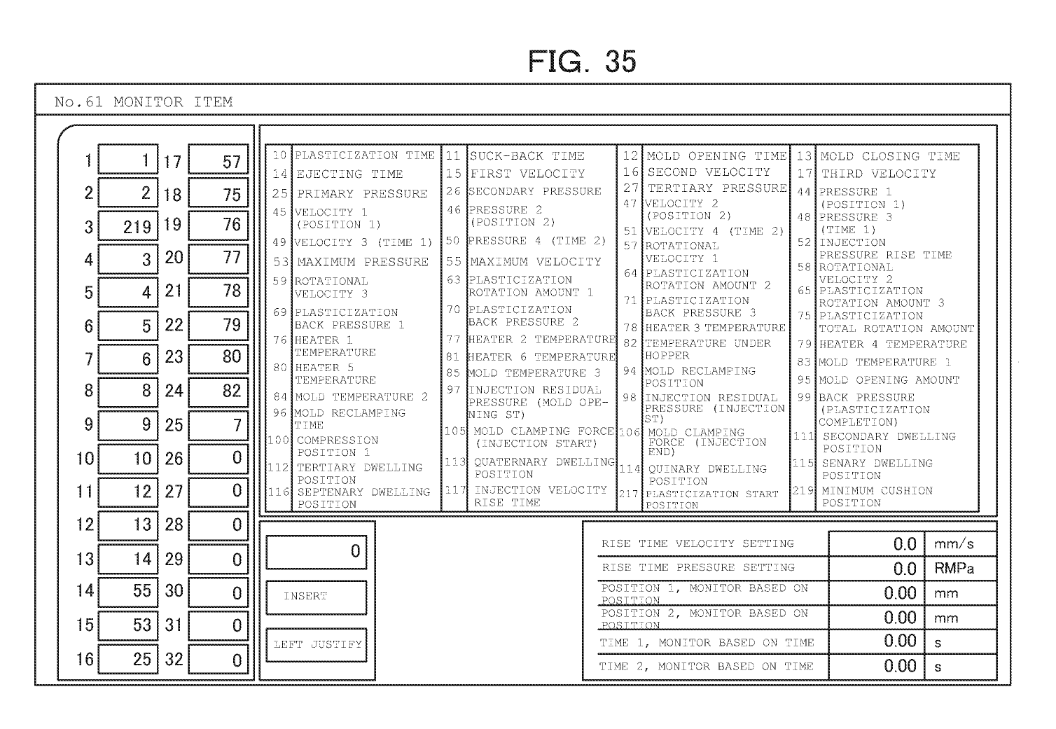

Although measured values of the respective portions of the molding machine detected by the group of sensors 11 are displayed on the monitor screen of the display portion 6, the operator can desirably select which measured values should be displayed on the display portion 6 and by which item names the measured values should be displayed thereon. As shown in FIG. 35, a large number of item names are prepared on the display portion 6. However, some item names which are not used according to some molding conditions are also included. Thus, when the item names which are not used are displayed on the monitor screen of the display portion 6, visibility of the monitor screen is degraded and operability of the molding machine consequently deteriorates. Accordingly, in order to improve the visibility of the monitor screen, it is convenient to urge the operator to pay attention when the item names which are not used are displayed on the monitor screen of the display portion 6. To this end, in the embodiment, as shown in a sixth row of FIG. 32, “Invalid items are included in monitor items” is stored in advance in the storage portion 4, as a criterion for determining that the molding condition setting value is inappropriate. When the item names which are not used are displayed on the monitor screen of the display portion, a determination message “Invalid items are included in monitor items” is outputted to the display portion 6, as shown in the same row. In addition thereto, a comment “Item names not used are set” is displayed on the display portion 6. In accordance with the determination message and the comment, the operator can select item names to be displayed on the monitor screen of the display portion 6.

### <Setting Value Diagnosis of Monitor Determination>

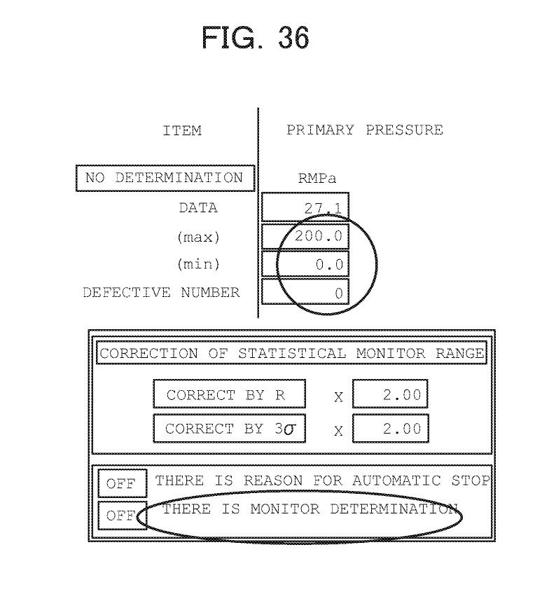

A function for determining occurrence/non-occurrence of a defective product based on the measured values of the respective portions of the molding machine detected by the group of sensors 11 is provide in the molding machine. For example, as shown in FIG. 36, “There is monitor determination” displayed on the monitor screen of the display portion 6 is switched ON, and predetermined numerical values are inputted into entry fields of an upper limit value and a lower limit value of defective product determination. Thus, it is possible to perform the defective product determination automatically. When “There is monitor determination” is switched OFF, the defective product determination is not performed. Accordingly, in order to prevent or reduce occurrence of a defective product, it is convenient to urge the operator to pay attention when “There is monitor determination” is switched OFF. To this end, in the embodiment, as shown in a seventh row of FIG. 32, “Monitor determination is OFF” is stored in advance in the storage portion 4, as a criterion for determining that the molding condition setting value is inappropriate. When the monitor determination of the molding machine is not valid, a determination message “Monitor determination is not valid” is outputted to the display portion 6, as shown in the same row. In addition thereto, a comment “Please check monitor determination setting” is displayed on the display portion 6. In accordance with the determination message and the comment, the operator can use the monitor determination function of the molding machine effectively so that occurrence of a defective product can be reduced.

### <Setting Value Diagnosis of Continuous Defective Product Setting>

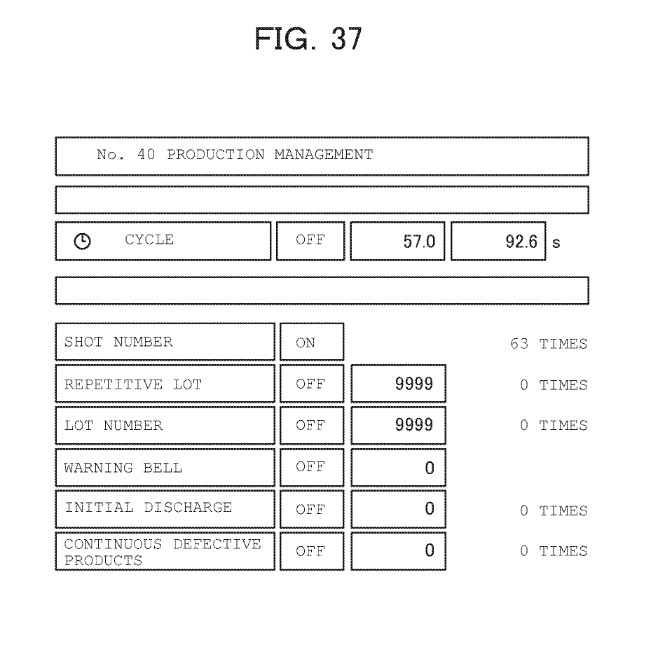

A function of counting the number of defective products molded continuously during continuous automatic operation is provided in the molding machine in addition to the function of determining occurrence/non-occurrence of a defective product. For example, as shown in FIG. 37, “Continuous Defective Products” displayed on the monitor screen of the display portion 6 is switched ON. In this manner, it is possible to display the number of the defective products molded continuously on the monitor screen. When “Continuous Defective Products” is switched OFF, counting of the number of defective products is not performed. Accordingly, in order to prevent or reduce continuous molding of defective products, it is convenient to urge the operator to pay attention when “Continuous Defective Products” is switched OFF. To this end, in the embodiment, as shown in an eighth row of FIG. 32, “Continuous defective product setting is OFF” is stored in the storage portion 4, as a criterion for determining that the molding condition setting value is inappropriate. When the continuous defective product setting of the molding machine is not valid, a determination message “Continuous defective product monitoring is OFF” is outputted to the display portion 6. In addition thereto, a comment “Please check continuous defective product setting” is displayed on the display portion 6. In accordance with the determination message and the comment, the operator can set the continuous defective product setting valid. Accordingly, the operator can effectively use the continuous defective product setting function of the molding machine so that continuous molding of defective products can be reduced.

### <Setting Value Diagnosis of Condition Storage>

By operation on the image selection unit 8, a molding condition set in the molding condition setting unit 30 can be stored in the operation condition setting storage portion 204 (see FIG. 2) provided in the control unit 20. In addition, by operation on the image selection unit 8, the molding condition stored in the operation condition setting storage portion 204 can be read onto the display portion 6 at any time. Further, when change is added to the molding condition read onto the display portion 6, the changed molding condition can be also stored in the operation condition setting storage portion 204. In consideration of the possibility that the changed molding condition might be used afterward, it is desirable that the changed molding condition is stored in advance in the operation condition setting storage portion 204. In an example of FIG. 38, files about the same product name “130131” are stored in the operation condition setting storage portion 204 with different names (classifications) added to these files in accordance with file created dates. When the changed molding condition is not stored in advance in the operation condition setting storage portion 204 differently from the example of FIG. 38 but a molded product is intended to be molded under the changed molding condition, resetting work of the molding condition needs to be performed by the molding condition setting unit 30. For this reason, workability becomes lowered. Accordingly, operation of the molding machine can be made efficient if the operator can be urged to pay attention when the changed molding condition is not stored in the operation condition setting storage portion 204 yet. Therefore, in the embodiment, as shown in a ninth row of FIG. 32, “There is an unstored molding condition” is stored in advance in the storage portion 4, as a criterion for determining that the molding condition setting value is inappropriate. When the molding condition is not stored yet, a determination message “Molding condition is not stored yet” is outputted to the display portion 6, as shown in the same row. In addition thereto, a comment “Molding condition storage data are changed” is displayed on the display portion 6. In accordance with the determination message and the comment, the operator can store the changed molding condition in the operation condition setting storage portion 204. Accordingly, the setting work of the molding condition, and hence, the operation efficiency of the molding machine can be enhanced.

### <Stability Control of Injection Pressure>

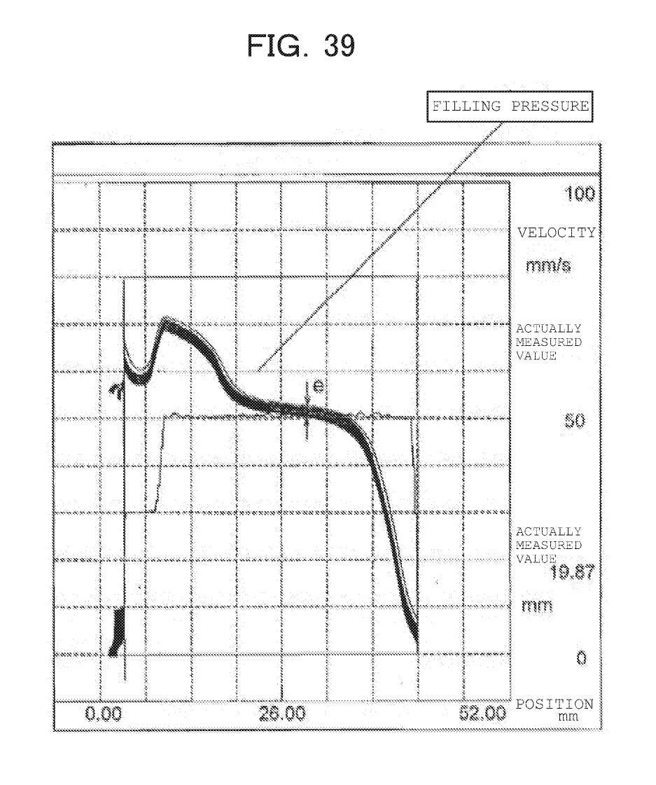

Since mold temperature or molding material temperature is unstable immediately after the start of continuous automatic operation, a certain level of variation is generated in the measured value of injection pressure. The measured value of filling pressure then becomes stable as the number of shots increases. Accordingly, even when a variation is generated in the measured value of the injection pressure, it is inappropriate to take measures instantly. However, production efficiency of good products can be enhanced if the operator can be urged to pay attention to a variation in the measured value and to check whether the variation is caused by the unstable mold temperature or molding material temperature or not immediately after the start of the continuous automatic operation. Therefore, in the embodiment, injection pressure data every measurement time from the start of injection to the end of injection for a predetermined number of shots (for example, 50 shots or 100 shots) are imported continuously into the measured value storage portion 202 of the control unit 20 (see FIG. 2). When displayed as an image on the display portion 6, the injection pressure data imported into the measured value storage portion 202 are transformed into a waveform shown in FIG. 39. In addition, the monitor arithmetic processing portion 203 of the control unit 20 (see FIG. 2) obtains a deviation e between a maximum value and a minimum value of filling pressure data every measurement time from the start of injection to the end of injection based on the injection pressure data imported into the measured value storage portion 202. When the obtained deviation is larger than a deviation reference value of the filling pressure, a determination message “The state of injection pressure is fluctuating” is displayed on the display portion 6, as shown in a tenth row of FIG. 32. In addition thereto, a comment “Pressure value is fluctuating. It is necessary to make diagnosis again” is displayed on the display portion 6. Thus, the operator can easily recognize that the filling pressure contains a variation which is larger than the reference value. In addition, by the diagnosis again, the operator can check whether the variation is caused by the unstable mold temperature or molding material temperature or not immediately after the start of the continuous automatic operation. Accordingly, it is possible to avoid unnecessary checking work or maintenance so that it is possible to enhance productivity of the molding machine body 10 as a whole.

### <Stability Control of Plasticization Time>

As described in the column (see paragraph [0051]) about the measured value control of the plasticization step time, the measured value of the metering step time fluctuates due to various factors such as the kind of the raw material. When the fluctuation amount is excessively large, a variation of the cycle time becomes large and productivity becomes poor. Accordingly, it is possible to suppress deterioration of the productivity if the operator can be urged to pay attention to the large fluctuation of the measured value of the plasticization step time. To this end, in the embodiment, the measured values of the plasticization step time for a predetermined number of shots (for example, 50 shots or 100 shots) are imported continuously into the measured value storage portion 202 of the control unit 20 (see FIG. 2) and a deviation e between a maximum value and a minimum value is obtained by the monitor arithmetic processing portion 203 of the control unit 20 (see FIG. 2). When the obtained deviation is larger than a deviation reference value of the plasticization step time, a determination message “Plasticization time is fluctuating” is displayed on the display portion 6, as shown in an eleventh row of FIG. 32. In addition thereto, a comment “Plasticization time is fluctuating. It is necessary to make diagnosis again” is displayed on the display portion 6. Thus, the operator can easily recognize that the filling pressure contains a variation larger than the reference value. In addition, by the diagnosis again, the operator can check whether the variation is caused by the unstable mold temperature or molding material temperature or not immediately after the start of the continuous automatic operation. Accordingly, it is possible to avoid unnecessary checking work or maintenance so that it is possible to enhance productivity of the molding machine body 10 as a whole.

Incidentally, the invention is aimed at diagnosing appropriateness of a preset molding condition according to a measured value detected during continuous automatic operation or operation stability of a molding machine to thereby inform an operator when the molding condition is inappropriate.

Diagnosis items are not limited to the items stated in the embodiment. It is a matter of course that diagnosis may be made on any other item. In addition, it is unnecessary to make diagnosis on all the items listed in the embodiment. The items can be increased or decreased suitably in accordance with the type of machine or the kind of molded product.

### REFERENCE SIGNS LIST

1 molding diagnostic device
2 input portion
3 comparison portion
4 storage portion
5 determination portion
6 display portion
7 display processing portion
8 image selection unit
10 molding machine body
11 measurement unit (group of sensors)
20 control unit
21 switch device
30 molding condition setting unit

1. A molding condition diagnostic device provided in a molding machine to determine whether a molding condition setting value is appropriate or not and inform an operator of a result of the determination, the molding machine having:
a molding machine body which is provided with a mold opening/closing device and an injection device injecting a molding material into a cavity of a closed mold so that the molding machine body can repeat a predetermined molding cycle including a plurality of steps to mold a predetermined molded product;
a molding condition setting unit which is operated by the operator to set a molding condition for the molding machine body;
a control unit which controls driving of the molding machine body based on a molding condition reference value determined by specifications of the molding machine body and the molding condition setting value set in the molding condition setting unit; and
a measurement unit which is provided in a predetermined region of the molding machine body to thereby measure and output a predetermined physical amount of the region where the measurement unit is provided;
the molding condition diagnostic device comprising:
an input portion which receives a measured value outputted from the measurement unit and the molding condition setting value set in the molding condition setting unit; a comparison portion which compares the measured value and the molding condition setting value both received by the input portion with each other; a storage portion in which a criterion for determining that the molding condition setting value is inappropriate is stored; a determination portion which determines whether a comparison result of the comparison portion satisfies the criterion stored in the storage portion or not; and a display portion which displays a specific determination message according to the measured value and the molding condition setting value compared with each other, when the determination portion determines that the comparison result of the comparison portion satisfies the criterion stored in the storage portion; wherein:
the display portion is configured to be able to display various display image data selected by the operator in various display modes so that the determination message can be displayed on a display screen of the display portion when display of the determination message is selected by the operator.

2. A molding condition diagnostic device provided in a molding machine to determine whether a molding condition setting value is appropriate or not and inform an operator of a result of the determination, the molding machine having:
a molding machine body which is provided with a mold opening/closing device and an injection device injecting a molding material into a cavity of a closed mold so that the molding machine body can repeat a predetermined molding cycle including a plurality of steps to mold a predetermined molded product;
a molding condition setting unit which is operated by the operator to set a molding condition for the molding machine body;
a control unit which controls driving of the molding machine body based on a molding condition reference value determined by specifications of the molding machine body and the molding condition setting value set in the molding condition setting unit; and
a measurement unit which is provided in a predetermined region of the molding machine body to thereby measure and output a predetermined physical amount of the region where the measurement unit is provided;
the molding condition diagnostic device comprising:
an input portion which receives a measured value outputted from the measurement unit and the molding condition reference value stored in the control unit; a comparison portion which compares the measured value and the molding condition reference value both received by the input portion with each other; a storage portion in which a criterion for determining that the molding condition setting value is inappropriate is stored; a determination portion which determines whether a comparison result of the comparison portion satisfies the criterion stored in the storage portion or not; and a display portion which displays a specific determination message according to the measured value and the molding condition reference value compared with each other, when the determination portion determines that the comparison result of the comparison portion satisfies the criterion stored in the storage portion; wherein:
the display portion is configured to be able to display various display image data selected by the operator in various display modes so that the determination message can be displayed on a display screen of the display portion when display of the determination message is selected by the operator.

3. A molding condition diagnostic device according to claim 1, wherein: one selected from diagnosis items as a diagnosis item for the molding condition setting value to be determined by the determination portion is set in advance in the control unit, the diagnosis items at least including:
primary pressure, the number of injection stages, dwelling velocity, the number of dwelling stages, injection execution torque, and a cushion amount in an injection step;
the number of plasticization stages, a plasticization time, metering density stabilization, a metering start position, a metering time, and metering execution torque in a plasticization step;
the number of mold closing stages, the number of mold opening stages, low-pressure mold clamping force, an intermediate timer time, a gate cutting start position, and load torque of a mold opening/closing motor in a mold opening/closing step;
the number of eject stages and load torque of an eject motor in an eject step;
a forcible stop time in an air blowing step;
mold clamping force in a mold clamping step;
a display item and a determination item displayed on the display portion; and
continuous defective product setting and molding condition storage set in the molding condition setting unit; and
the control unit controls the determination portion to automatically execute determination about each of the diagnosis items.

4. A molding condition diagnostic device according to claim 2, wherein: diagnosis items for molding condition setting values to be determined by the determination portion are set in advance in the control unit, the diagnosis items at least including: a dwelling time, injection load torque and a filling rate in an injection step; a suck-back amount and metering load torque in a metering step; an electric conduction rate into a heating cylinder heater during temperature adjustment of a heating cylinder and during molding operation; and the control unit controls the determination portion to automatically execute determination about each of the diagnosis items.

5. A molding condition diagnostic device according to claim 1, wherein: when an instruction to perform molding condition diagnosis is issued from the operator during continuous automatic operation, the control unit samples the measured values for a preset number of shots and controls the determination portion to automatically execute determination about each of all preset diagnosis items based on the sampled measured values.

6. A molding diagnostic device according to claim 1, wherein:
when an instruction to perform molding condition diagnosis is issued from the operator during continuous automatic operation, the control unit samples the measured values for a preset number of shots and controls the determination portion to automatically execute determination about each of all preset diagnosis items based on the sampled measured values; and
the determination portion determines whether a deviation of the sampled measured values for the preset number of shots is larger than a deviation reference value stored in the storage portion or not, and the control unit outputs a specific determination display according to the kind of the measured values to the display portion when the determination portion determines that the deviation of the measured values for the preset number of shots is larger than the deviation reference value stored in the storage portion.

7. A molding condition diagnostic device according to claim 1, wherein:
when an instruction to perform molding condition diagnosis is issued from the operator during continuous automatic operation, the control unit samples the measured values for a preset number of shots and controls the determination portion to automatically execute determination about each of all preset diagnosis items based on the sampled measured values;
the determination portion determines whether a deviation of the sampled measured values for the preset number of shots is larger than a deviation reference value stored in the storage portion or not, and the control unit outputs a specific determination display corresponding to the kind of the measured values to the display portion when the determination portion determines that the deviation of the measured values for the preset number of shots is larger than the deviation reference value stored in the storage portion; and
the diagnosis items including an injection time and injection pressure in an injection step, a plasticization time in a plasticization step, nozzle temperature during molding operation, and a mold opening time, a mold closing time and a product ejecting time in a mold opening/closing step are set in advance in the control unit, and the control unit controls the determination portion to automatically execute determination about each of the diagnosis items.

8. A molding condition diagnostic device according to claim 2, wherein: when an instruction to perform molding condition diagnosis is issued from the operator during continuous automatic operation, the control unit samples the measured values for a preset number of shots and controls the determination portion to automatically execute determination about each of all preset diagnosis items based on the sampled measured values.

9. A molding diagnostic device according to claim 2, wherein:
when an instruction to perform molding condition diagnosis is issued from the operator during continuous automatic operation, the control unit samples the measured values for a preset number of shots and controls the determination portion to automatically execute determination about each of all preset diagnosis items based on the sampled measured values; and
the determination portion determines whether a deviation of the sampled measured values for the preset number of shots is larger than a deviation reference value stored in the storage portion or not, and the control unit outputs a specific determination display corresponding to the kind of the measured values to the display portion when the determination portion determines that the deviation of the measured values for the preset number of shots is larger than the deviation reference value stored in the storage portion.

10. A molding condition diagnostic device according to claim 2, wherein:
when an instruction to perform molding condition diagnosis is issued from the operator during continuous automatic operation, the control unit samples the measured values for a preset number of shots and controls the determination portion to automatically execute determination about each of all preset diagnosis items based on the sampled measured values;
the determination portion determines whether a deviation of the sampled measured values for the preset number of shots is larger than a deviation reference value stored in the storage portion or not, and the control unit outputs a specific determination display corresponding to the kind of the measured values to the display portion when the determination portion determines that the deviation of the measured values for the preset number of shots is larger than the deviation reference value stored in the storage portion; and
the diagnosis items including an injection time and injection pressure in an injection step, a plasticization time in a plasticization step, nozzle temperature during molding operation, and a mold opening time, a mold closing time and a product ejecting time in a mold opening/closing step are set in advance in the control unit, and the control unit controls the determination portion to automatically execute determination about each of the diagnosis items.
